(19) United States
(12) Patent Application Publication
(10) Pub. No.: US 2026/0208505 A1
(43) Pub. Date: Jul. 23, 2026

(54) INKJET PRINTER

(71) Applicant: Roland DG Corporation, Hamamatsu-shi (JP)

(72) Inventors: Ryosuke NONAKA, Hamamatsu-shi (JP); Yukihiro TOKUNAGA, Hamamatsu-shi (JP); Naoki KOTOBUKI, Hamamatsu-shi (JP); Ryo BABA, Hamamatsu-shi (JP); Nobuyoshi SUZUKI, Hamamatsu-shi (JP); Takayuki MORIKAMI, Hamamatsu-Shi (JP)

(21) Appl. No.: 19/280,315

(22) Filed: Jul. 25, 2025

Related U.S. Application Data
(63) Continuation of application No. PCT/JP2023/002265, filed on Jan. 25, 2023.

(51) Int. Cl. B41J 11/00; B41J 29/377

(52) U.S. Cl. CPC B41J 11/00242; B41J 11/0022; B41J 11/0045; B41J 29/377

(57) ABSTRACT

An inkjet printer includes a support table to support a recording medium, an ink head to discharge ink toward the recording medium, a transporter to transport the recording medium in a transportation direction, a guide located beyond the support table in a downstream direction of the transportation direction to guide a movement of the recording medium, a heater assembly to heat the guide, and a controller including a warm-up temperature setting portion, in which a warm-up temperature as a temperature at the time of warm-up driving is set, a printing-time temperature setting portion, in which a printing-time temperature, which is a temperature at the time of printing and is higher than the warm-up temperature, is set, and a transportation controller configured or programmed to transport the recording medium in the downstream direction of the transportation direction by a predetermined distance after the temperature reaches the printing-time temperature but before printing starts.

### CROSS REFERENCE TO RELATED APPLICATIONS

This application is a Continuation Application of PCT Application No. PCT/JP 2023/002265 filed on Jan. 25, 2023. The entire contents of this application are hereby incorporated herein by reference.

### BACKGROUND OF THE INVENTION

### 1. Field of the Invention

The present invention relates to inkjet printers.

### 2. Description of the Related Art

Conventionally, an inkjet printer performing printing on a recording medium by an inkjet system is known. This type of inkjet printer includes, for example, a platen on which the recording medium is to be placed, and an ink head discharging ink onto the recording medium placed on the platen. There is also an inkjet printer using a certain type of ink and including a drying device drying the ink discharged onto the recording medium.

For example, Japanese Patent Application Publication No. 2022-119541 discloses an inkjet printer including a drying device sending hot air toward a guide, for a recording medium, that is provided downstream with respect to the platen. The drying device disclosed in Japanese Patent Application Publication No. 2022-119541 includes a case member including an absorbing opening and an exhaust opening, as well as a fan and a heater that are housed in the case member. The case member is provided so as to face the guide, and the exhaust opening is directed toward the guide. The drying device is configured to drive the fan to absorb external air from the absorbing opening and to send the air heated by the heater toward the recording medium on the guide from the exhaust opening.

When hot air is blown to the guide in such an inkjet printer as disclosed in Japanese Patent Application Publication No. 2022-119541, the recording medium placed on the platen adjacent to the guide may possibly have a temperature thereof increased. When the temperature of the recording medium is increased, the recording medium may undesirably rise because the recording medium stretches although a portion, of the recording medium, that is on the platen is unmovable due to being pressed by a transporter. An image printed on the recording medium in such a rising state has a low printing quality.

### SUMMARY OF THE INVENTION

Example embodiments of the present invention provide inkjet printers that each reduce or prevent such a rise of a recording medium on a support table although including a heater assembly to dry ink.

An inkjet printer disclosed herein includes a support table to support a recording medium, an ink head to discharge ink toward the recording medium supported by the support table, a transporter to transport the recording medium supported by the support table in a predetermined transportation direction, a guide located beyond the support table in a downstream direction of the transportation direction to guide a movement of the recording medium, a heater assembly to heat the guide, a temperature sensor to measure a temperature of the heater assembly or the guide, and a controller configured or programmed to include a warm-up temperature setting portion in which a warm-up temperature, which is a temperature at the time of warm-up driving, is set, a printing-time temperature setting portion in which a printing-time temperature, which is a temperature at the time of printing and is higher than the warm-up temperature, is set, a temperature controller configured or programmed to control the heater assembly to control the temperature measured by the temperature sensor, and a first transportation controller configured or programmed to the transporter to transport the recording medium, the temperature controller is configured or programmed to increase the temperature measured by the temperature sensor to the warm-up temperature, to maintain the temperature at the warm-up temperature, and then to increase the temperature to the printing-time temperature, and the first transportation controller is configured or programmed to transport the recording medium in the downstream direction of the transportation direction by a predetermined distance after the temperature measured by the temperature sensor reaches the printing-time temperature but before printing is started.

With the above-described inkjet printer, the rise of the recording medium on the support table, which is caused by a temperature increase of the recording medium on the guide and occurs by the recording medium being pressed by the transporter and thus being immovable, is reduced or prevented by the recording medium being transported before printing is performed.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is perspective view of a printer according to an example embodiment of the present invention.

FIG. 2 is a front view of a printer according to an example embodiment of the present invention.

FIG. 3 is a cross-sectional view taken along line B-B in FIG. 1.

FIG. 4 is a plan view of a drying device.

FIG. 5 is a front view of the drying device.

FIG. 6A is a rear view of the drying device.

FIG. 6B is a partially enlarged view of FIG. 6A.

FIG. 7A is a rear view of the drying device in a state where a rear wall is removed.

FIG. 7B is a partially enlarged view of FIG. 7A.

FIG. 8 is a front view of an attachment plate.

FIG. 9 is a perspective view of a spacer.

FIG. 10 is a perspective view showing a second air blowing chamber nozzle in a state where a spacer is sandwiched.

FIG. 11A is a cross-sectional view of an area in the vicinity of a border between a heating chamber and the second air blowing chamber nozzle.

FIG. 11B is a cross-sectional view of the area in the vicinity of the border between the heating chamber and the second air blowing chamber nozzle before a sponge is sandwiched.

FIG. 11C is a cross-sectional view of the area in the vicinity of the border between the heating chamber and the second air blowing chamber nozzle in a state where the rear wall is deformed by heat.

FIG. 12 is a perspective view of a downstream guide with a portion thereof not being shown.

FIG. 13 is a control block diagram of the printer,

FIG. 14 shows a flow of air in the drying device.

FIG. 15A is a first half of a flowchart showing an operation of the printer.

FIG. 15B is a second half of the flowchart showing the operation of the printer.

FIG. 16 is a flowchart showing air volume control in detail.

FIG. 17 is a flowchart showing an operation of the printer after a recording medium is cut.

### DETAILED DESCRIPTION OF THE EXAMPLE EMBODIMENTS

Hereinafter, inkjet printers (hereinafter, referred to simply as a “printer” or “printers”) according to example embodiments of the present invention will be described with reference to the drawings. The example embodiments described herein are not intended to specifically limit the present invention. Elements and portions having the same functions bear the same reference signs, and overlapping descriptions will be omitted or simplified as appropriate.

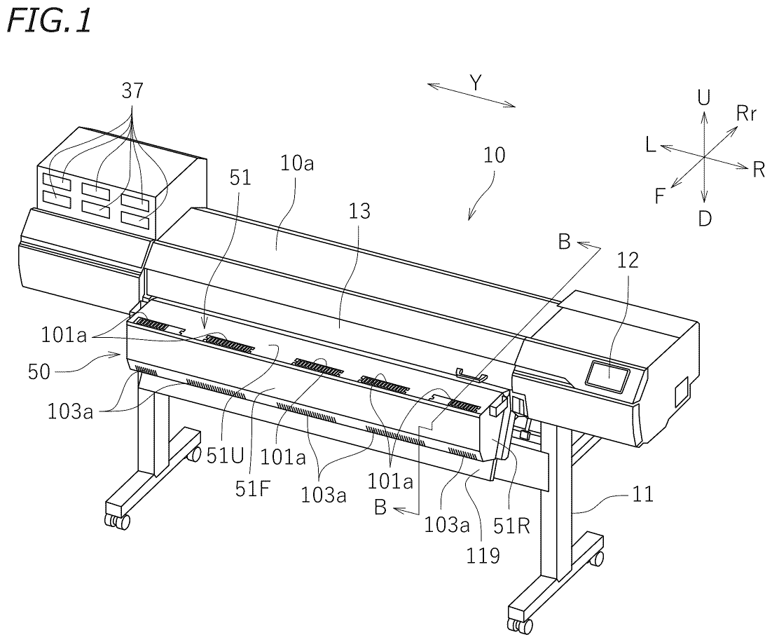

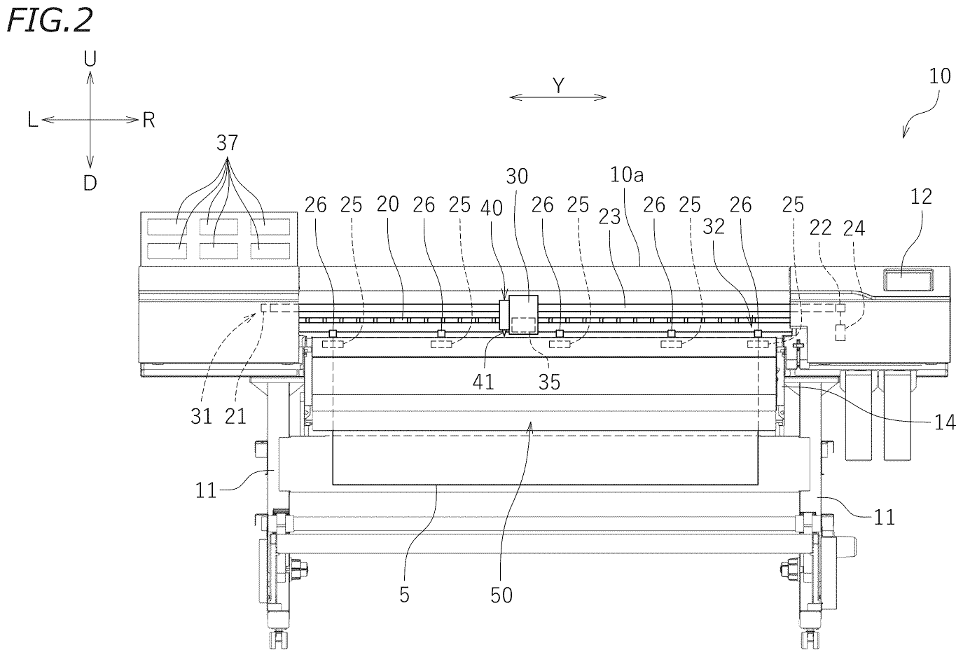

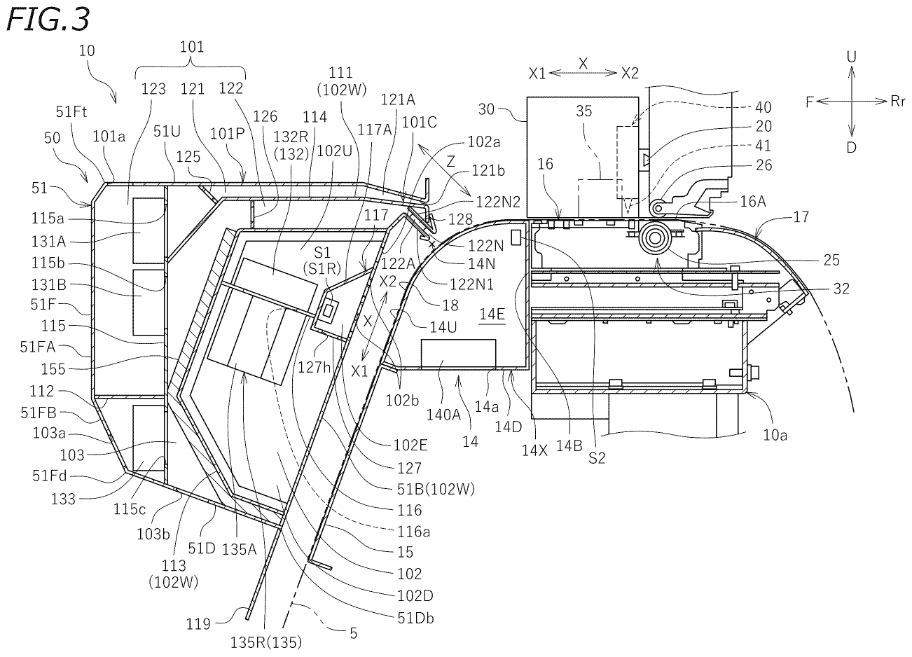

FIG. 1 is a perspective view of a printer 10 according to an example embodiment. FIG. 2 is a front view of the printer 10. FIG. 3 is a cross-sectional view taken along B-B in FIG. 1. FIG. 2 omits non-heating chamber absorbing openings 103a and non-heating chamber exhaust openings 103b. The printer 10 performs printing on a recording medium 5. Hereinafter, the terms “left”, “right”, “up” and “down” respectively refer to left, right, up and down as seen from an operator facing a front side of the printer 10. In the drawings, letters F, Rr, L, R, U and D respectively refer to front, rear, left, right, up and down.

The recording medium 5 is, for example, a recording paper sheet. The recording medium 5 is not limited to a recording paper sheet. The recording medium 5 may be formed of paper such as plain paper, inkjet printing paper or the like, a resin material such as polyvinylchloride (PVC), polyester or the like, a metal plate of aluminum, iron or the like, a glass plate, a wooden plate, a cardboard material or the like.

As shown in FIG. 1, the printer 10 includes a body 10a, legs 11, an operation panel 12, and a front cover 13. The body 10a includes a casing extending in a left-right direction. The legs 11 support the body 10a, and are provided on a bottom surface of the body 10a. The operation panel 12 is provided on, for example, a front surface in a right portion of the body 10a. Note that there is no specific limitation on the position of the operation panel 12. The operation panel 12 is used by a user to make an operation regarding printing. The front cover 13 is pivotable with respect to the body 10a. The front cover 13 is formed of, for example, a transparent acrylic resin. FIG. 2 omits the front cover 13.

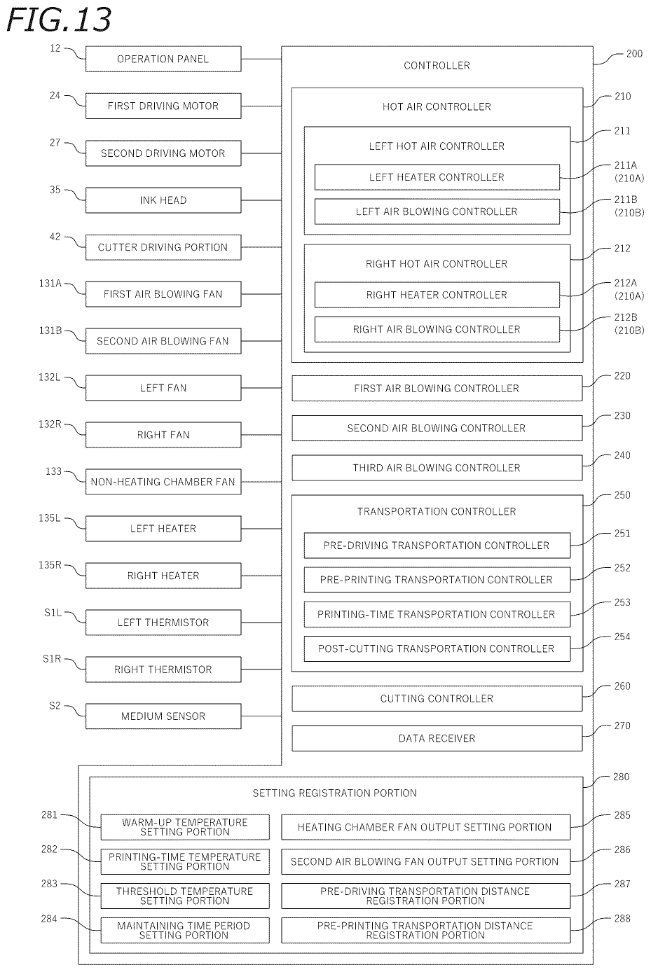

As shown in FIG. 3, the printer 10 includes a platen 16 to support the recording medium 5, an ink head 35 to discharge ink onto the recording medium 5 supported by the platen 16, a transporter 32 to transport the recording medium 5 supported by the platen 16 in a predetermined transportation direction X, a downstream guide 14 provided to the front of the platen 16 to guide a movement of the recording medium 5, a sheet cutter 40 cutting the recording medium 5 after the printing is finished, and a controller 200 (see FIG. 13). A downstream direction X1 of the transportation direction X is a direction from the platen 16 toward the downstream guide 14, and an upstream direction X2 is an opposite direction thereto. As shown in FIG. 3, the downstream guide 14 is inclined forward and downward. Therefore, in this example embodiment, the downstream direction X1 of the transportation direction X extends obliquely downward and forward on the downstream guide 14. The downstream direction X1 of the transportation direction X is the forward direction on the platen 16. The upstream direction X2 of the transportation direction X is the rearward direction on the platen 16, and extends obliquely upward and rearward on the downstream guide 14. In this example embodiment, the transportation direction X of the recording medium 5 by the transporter 32 curves in an up-down direction at a position downstream with respect to the platen 16.

As shown in FIG. 3, the printer 10 includes an upstream guide 17 located beyond the platen 16 in the upstream direction X2 of the transportation direction X, in addition to the downstream guide 14. In this example embodiment, the upstream guide 17 is provided to the rear of the platen 16. The upstream guide 17 guides a movement of the recording medium 5 toward the platen 16.

As shown in FIG. 3, the recording medium 5 is placed on the platen 16. The printing on the recording medium 5 is performed on the platen 16. The platen 16 extends in the left-right direction. A top surface 16A of the platen 16 is flat.

As shown in FIG. 2, the transporter 32 includes grit rollers 25, pinch rollers 26, and a second driving motor 27 (see FIG. 13) to drive the grit rollers 25. The grit rollers 25 are provided on the platen 16. In this example embodiment, the grit rollers 25 are at least partially buried in the platen 16. The pinch rollers 26 press the recording medium 5 from above. The pinch rollers 26 are provided above the grit rollers 25. The pinch rollers 26 are provided at positions facing the grit rollers 25. The pinch rollers 26 are movable in the up-down direction. When the second driving motor 27 is driven to rotate the grit rollers 25 in a state where the recording medium 5 is sandwiched between the grit rollers 25 and the pinch rollers 26, the recording medium 5 is transported in the transportation direction X. There is no specific limitation on the position of each of the grit rollers 25 and the pinch rollers 26. There is no specific limitation on the number of the grit rollers 25 and the number of the pinch rollers 26. The transporter 32 is not limited to one including the grit rollers 25 and the pinch rollers 26.

The ink head 35 discharges thermosetting ink onto the recording medium 5. In this example embodiment, the ink head 35 discharges aqueous ink onto the recording medium 5. The thermosetting ink is not limited to aqueous ink, and may be solvent ink or the like. As shown in FIG. 3, the ink head 35 is located above the platen 16. The ink head 35 is movable in the left-right direction. In this example embodiment, the ink head 35 is connected with ink cartridges 37 via an ink supply path not shown.

As the aqueous ink, for example, latex ink is preferably usable. The latex ink contains a solvent, a colorant and a binder resin. In the latex ink, the binder resin is dispersed or emulsified in a solvent. As the solvent, for example, water, or one type of, or two or more types of, water-soluble organic solvent (lower alcohol, lower ketone, etc.) that may be uniformly mixed with water, may be appropriately selected. The latex ink contains a solvent at about 50% by mass or higher and about 90% by mass or lower with respect to the total mass thereof, for example. As the colorant, a conventional colorant contained in the latex ink may be appropriately selected. Examples of the colorant include a dye such as a water-soluble dye, a pigment or the like. As the binder resin, a conventional binder resin contained in the latex ink may be appropriately selected.

As shown in FIG. 2, the printer 10 includes a head moving device 31 moving the ink head 35 in the left-right direction. The ink head 35 is mounted on a carriage 30 and moves in the left-right direction together with the carriage 30. Hereinafter, the direction in which the carriage 30 moves will be referred to also as a “scanning direction Y”. The scanning direction Y is one of perpendicular directions that are perpendicular to the transportation direction X. Note that the scanning direction Y is not limited to the left-right direction, and the transportation direction X is not limited to a front-rear direction (including an oblique front-rear direction), either. The scanning direction Y and the transportation direction X may be appropriately set in accordance with the form of the printer 10 or the like.

The head moving device 31 includes a guide rail 20, a first pulley 21, a second pulley 22, an endless belt 23, a first driving motor 24, and the carriage 30. The guide rail 20 guides a movement of the carriage 30 in the scanning direction Y. As shown in FIG. 3, the guide rail 20 is located above the platen 16. As shown in FIG. 2, the guide rail 20 extends in the scanning direction Y. The first pulley 21 is provided at a left end of the guide rail 20. The second pulley 22 is provided at a right end of the guide rail 20. The belt 23 is wound along the first pulley 21 and the second pulley 22. In this example embodiment, the second pulley 22 is connected with the first driving motor 24. Note that the first driving motor 24 may be connected with the first pulley 21. The first driving motor 24 is driven to rotate the second pulley 22, so that the belt 23 runs between the first pulley 21 and the second pulley 22.

As shown in FIG. 2, the carriage 30 is attached to the belt 23. The carriage 30 is located above the platen 16. As shown in FIG. 3, the carriage 30 is in engagement with the guide rail 20, and is slidable with respect to the guide rail 20. In this example embodiment, the head moving device 31 drives the first driving motor 24 to run the belt 23. Along with the movement of the carriage 30 in the scanning direction Y, the ink head 35 mounted on the carriage 30 moves in the scanning direction Y.

The sheet cutter 40 cuts the recording medium 5 while moving across the recording medium 5 in the scanning direction Y to cut the recording medium 5 into a downstream portion and an upstream portion with respect to the transportation direction X. As shown in FIG. 2, the sheet cutter 40 is supported by the carriage 30, and moves in the scanning direction Y together with the carriage 30. The sheet cutter 40 includes a cutter 41 capable of cutting the recording medium 5, and a cutter driving portion 42 (see FIG. 13) moving the cutter 41 in the up-down direction. The cutter 41 is located above the platen 16 when not in use, for example, while an image is being printed on the recording medium 5. For cutting the recording medium 5, the cutter driving portion 42 moves the cutter 41 to a position below the recording medium 5 placed on the platen 16. In a state where the cutter 41 is at such a lowered position, the carriage 30 is moved in the scanning direction Y, so that the recording medium 5 is cut.

As shown in FIG. 1, the printer 10 includes a drying device 50. The drying device 50 blows air to ink discharged onto the recording medium 5 to dry the ink. In more detail, the drying device 50 blows hot air to the downstream guide 14 to dry the ink on the recording medium 5 moving on the downstream guide 14. The drying device 50 also heats the downstream guide 14 with the hot air. The drying device 50 blows air of approximately room temperature (hereinafter, referred to simply as “room-temperature air”) to the recording medium 5 supported by the platen 16. Hereinafter, sending the room-temperature air toward the recording medium 5 placed on the platen 16 will be referred to as “initial air blowing”, and sending hot air toward the recording medium 5 guided by the downstream guide 14 will be referred to as “complete drying”.

As shown in FIG. 3, the drying device 50 is located to the front of the platen 16. The drying device 50 is located so as to face the downstream guide 14. At least a portion of the drying device 50 overlaps the downstream guide 14 as seen in a plan view. As shown in FIG. 2, at least a portion of the drying device 50 overlaps the downstream guide 14 as seen in a front view. The drying device 50 is provided so as to be detachable from the body 10a.

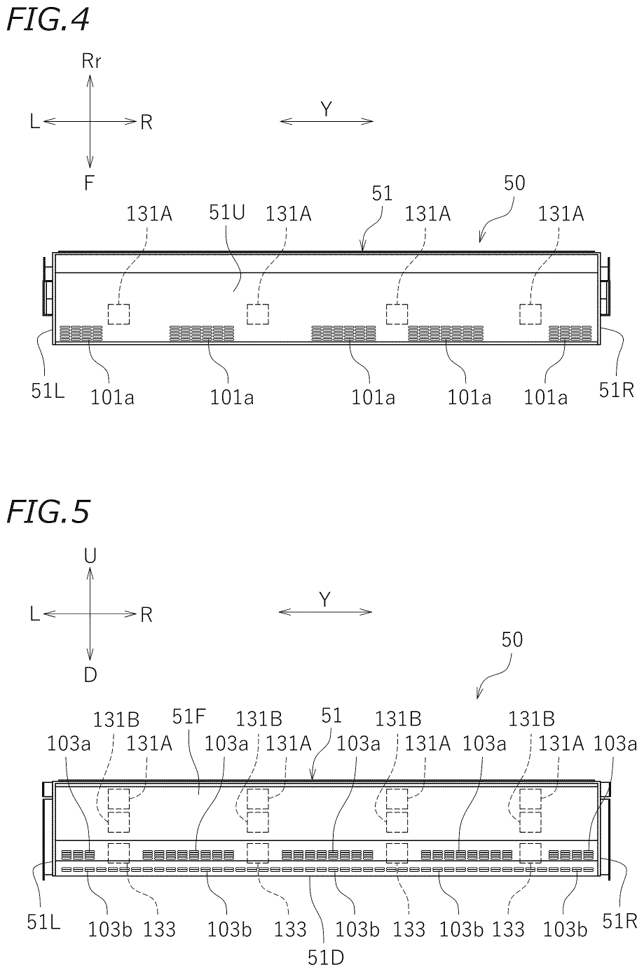

As shown in FIG. 3, the drying device 50 includes a box-shaped body case 51. FIG. 4 is a plan view of the drying device 50. FIG. 5 is a front view of the drying device 50. As shown in FIG. 3 through FIG. 5, the body case 51 includes a front wall 51F extending upward, a top wall 51U extending rearward from a top end 51 Ft of the front wall 51F, and a bottom wall 51D extending rearward from a bottom end 51Fd of the front wall 51F. A rear wall 51B extending upward is connected with a rear end 51Db of the bottom wall 51D. The rear wall 51B is a panel closing a rear surface of the body case 51. The bottom wall 51D is located below the top wall 51U, and the rear wall 51B is located to the rear of the front wall 51F. The body case 51 includes a left wall 51L and a right wall 51R respectively to the left of, and to the right of, the front wall 51F, the top wall 51U, the bottom wall 51D and the rear wall 51B. The front wall 51F, the top wall 51U, the bottom wall 51D, the rear wall 51B, the left wall 51L and the right wall 51R may be flat, curved, or bent. The front wall 51F, the top wall 51U, the bottom wall 51D, the rear wall 51B, the left wall 51L and the right wall 51R may be formed of a single structure or a combination of a plurality of structures. A portion of, or the entirety of, at least one of the front wall 51F, the top wall 51U, the bottom wall 51D, the rear wall 51B, the left wall 51L and the right wall 51R may be integrated with a portion of, or the entirety of, at least one other of the front wall 51F, the top wall 51U, the bottom wall 51D, the rear wall 51B, the left wall 51L and the right wall 51R.

As shown in FIG. 3, the drying device 50 includes an extending wall 119 extending downward from the bottom wall 51D or the rear wall 51B. In this example embodiment, the extending wall 119 is attached to the bottom wall 51D. The extending wall 119 extends forward and downward from a bottom end of the bottom wall 51D. Note that there is no specific limitation on the position to which the extending wall 119 is attached. The extending wall 119 may be attached to the rear wall 51B. The extending wall 119 may extend forward and downward from a bottom end of the rear wall 51B. The extending wall 119 may not be provided.

As shown in FIG. 3, an air blowing chamber 101, a heating chamber 102 and a non-heating chamber 103 are provided inside the body case 51. The drying device 50 includes a partition wall 111 separating the inside of the body case 51 into the air blowing chamber 101 and the heating chamber 102, a partition wall 112 separating the inside of the body case 51 into the air blowing chamber 101 and the non-heating chamber 103, and a partition wall 113 separating the inside of the body case 51 into the heating chamber 102 and the non-heating chamber 103.

The heating chamber 102 houses a plurality of heaters 135 and a plurality of heating chamber fans 132 respectively corresponding to the plurality of heaters 135. The heating chamber fans 132 send air heated by the heaters 135 to generate hot air. The heating chamber 102 is defined by the partition wall 111, the partition wall 113, the rear wall 51B, the left wall 51L and the right wall 51R. The partition wall 111 and the partition wall 113 are preferably bent plates, for example. Hereinafter, the walls defining the heating chamber 102 will be referred to also as “heating chamber walls 102W” when appropriate. Note that the heating chamber walls 102W are not limited to the above-mentioned walls. The heating chamber walls 102W are located to enclose the heaters 135 and the heating chamber fans 132. The heating chamber fans 132 merely need to be located so as to be capable of blowing air to into the heating chamber 102, and do not need to be located inside the heating chamber 102. In this example embodiment, the heating chamber walls 102W are formed of stainless steel, which has a thermal conductivity lower than that of iron, for example, and does not easily dissipate heat. The drying device 50 further includes a partition wall 116 separating the inside of the heating chamber 102 into an upstream chamber 102U and a downstream chamber 102D, a partition wall 117 separating an exit chamber 102E from the downstream chamber 102D and the upstream chamber 102U in the heating chamber 102, and a rectifier plate 127.

The upstream chamber 102U is defined by the partition wall 111, the partition wall 116, the partition wall 117, the left wall 51L and the right wall 51R. The downstream chamber 102D is defined by the partition wall 111, the partition wall 113, the partition wall 116, the rectifier plate 127, the rear wall 51B, the left wall 51L and the right wall 51R. The exit chamber 102E is defined by the partition wall 117, the rectifier plate 127, the rear wall 51B, the left wall 51L and the right wall 51R. The downstream chamber 102D has a volume larger than a volume of the upstream chamber 102U, and the volume of the upstream chamber 102U is larger than a volume of the exit chamber 102E.

The rear wall 51B of the heating chamber 102 includes a heating chamber absorbing opening 102a and heating chamber exhaust openings 102b formed therein. The heating chamber absorbing opening 102a and the heating chamber exhaust openings 102b are opened toward the downstream guide 14. The heating chamber absorbing opening 102a communicates the outside of the body case 51 and the upstream chamber 102U of the heating chamber 102 to each other. The heating chamber exhaust openings 102b communicate the exit chamber 102E of the heating chamber 102 and the outside of the body case 51 to each other.

The plurality of heating chamber fans 132 send air such that the air is absorbed from the heating chamber absorbing opening 102a, passes the heaters 135 and is exhausted from the heating chamber exhaust openings 102b. In more detail, the air flowing in the heating chamber 102 flows into the upstream chamber 102U from the heating chamber absorbing opening 102a, is sent from the upstream chamber 102U to the downstream chamber 102D by the heating chamber fans 132 attached to the partition wall 116, passes a through-holes 127h of the rectifier plate 127 to flow into the exit chamber 102E from the downstream chamber 102D, and is exhausted to the outside of the heating chamber 102 from the exit chamber 102E via the heating chamber exhaust openings 102b. The hot air generated by the heating chamber fans 132 being driven is exhausted from the heating chamber exhaust openings 102b. In this example embodiment, as shown in FIG. 3, the heating chamber absorbing opening 102a and the heating chamber exhaust openings 102b are opened rearward and downward toward the downstream guide 14. A pressure of the upstream chamber 102U is set to a negative pressure, a pressure of the downstream chamber 102D is set to a positive pressure, and a pressure of the exit chamber 102E is set to a positive pressure lower than the pressure of the downstream chamber 102D. As shown in FIG. 3, the rectifier plate 127 is located to the rear of the heating chamber fans 132, and the through-holes 127h of the rectifier plate 127 are located at positions not facing exits of the plurality of heating chamber fans 132. The rectifier plate 127 includes a guide plate 117A directing the air flowing in the downstream chamber 102D toward the heating chamber exhaust openings 102b. In this example embodiment, the guide plate 117A is defined by a portion of the partition wall 117. That is, the portion of the partition wall 117 also acts as the guide plate 117A. Note that there is no specific limitation on the configuration of the guide plate 117A, and the guide plate 117A may be separate from the partition wall 117.

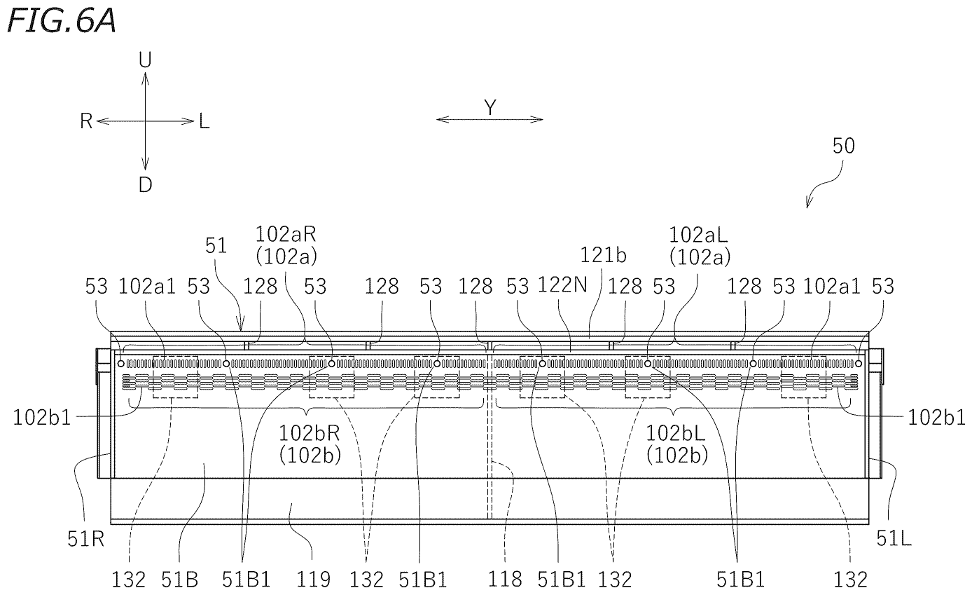

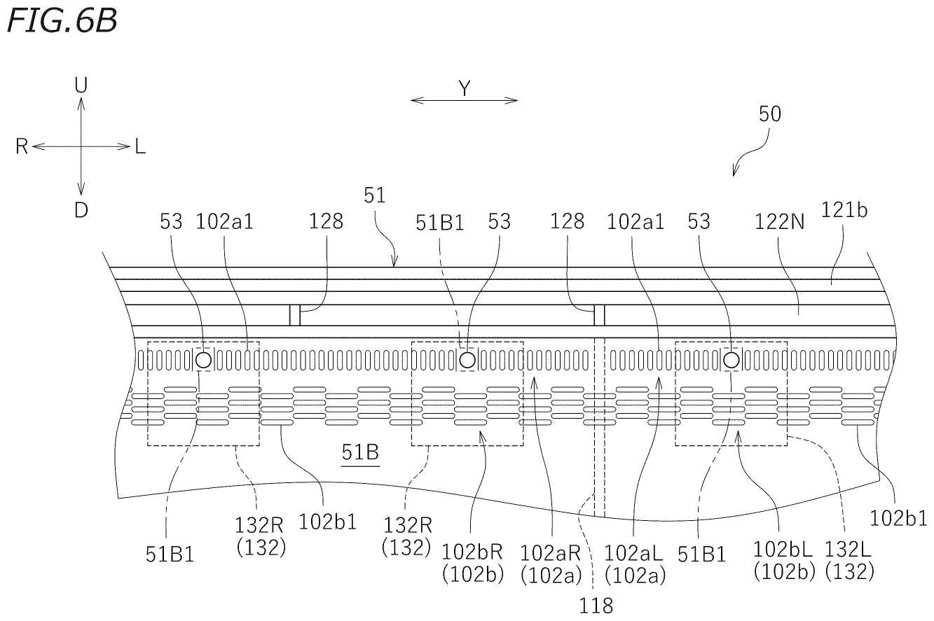

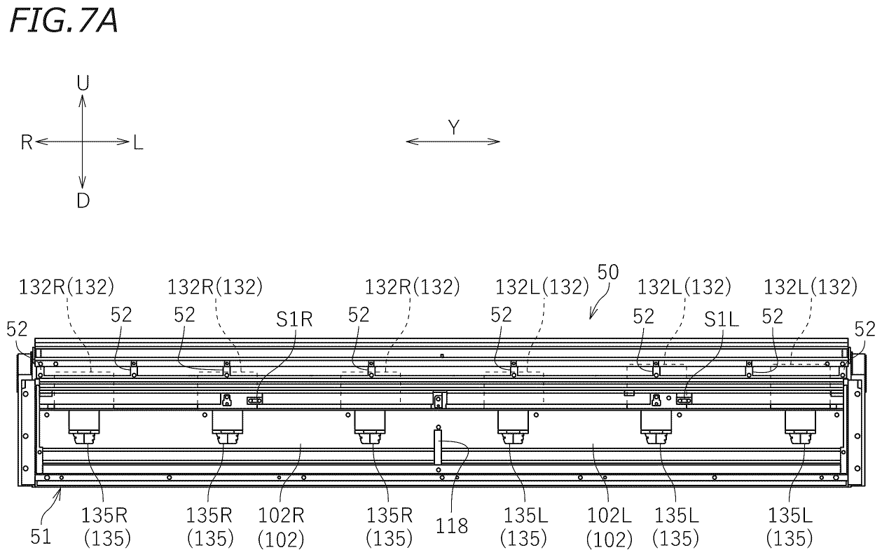

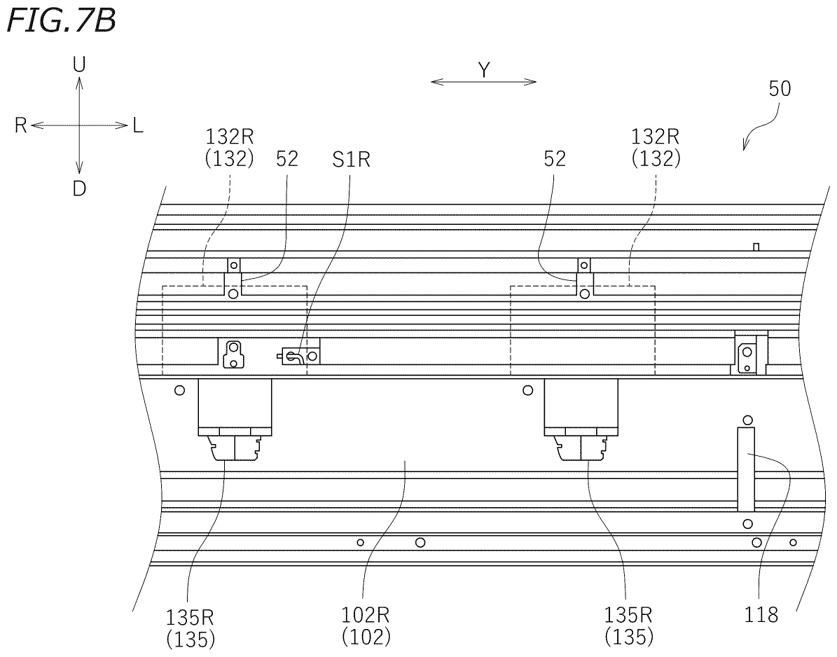

FIG. 6A is a rear view of the drying device 50. FIG. 6B is a partially enlarged view of FIG. 6A. FIG. 7A is a rear view of the drying device 50 in a state where the rear wall 51B is removed. FIG. 7B is a partially enlarged view of FIG. 7A. In this example embodiment, as shown in FIG. 7A, the heating chamber 102 is separated into a left heating chamber 102L and a right heating chamber 102R. The heating chamber 102 includes a partition wall 118 extending in the front-rear direction and the up-down direction and separating the inside of the heating chamber 102 into the left heating chamber 102L and the right heating chamber 102R. The left heating chamber 102L is provided in a portion, of the heating chamber 102, that is to the left of the partition wall 118. The right heating chamber 102R is provided in a portion, of the heating chamber 102, that is to the right of the partition wall 118. The left heating chamber 102L and the right heating chamber 102R are arranged in a line in the scanning direction Y. In this example embodiment, the partition wall 118 separates the heating chamber 102 equally into two. The left heating chamber 102L and the right heating chamber 102R may have different sizes from each other.

As shown in FIG. 6A, the heating chamber absorbing openings 102a extend in the scanning direction Y. The heating chamber absorbing openings 102a include left absorbing openings 102aL provided in the left heating chamber 102L and right absorbing openings 102aR provided in the right heating chamber 102R. The heating chamber exhaust openings 102b also extend in the scanning direction Y. The heating chamber exhaust openings 102b include a left exhaust opening 102bL provided in the left heating chamber 102L and a right exhaust opening 102bR provided in the right heating chamber 102R.

Regarding the scanning direction Y, the left absorbing openings 102aL and the right absorbing openings 102aR are respectively provided in substantially the entirety of a left half and a right half of the body case 51. In this example embodiment, as shown in FIG. 6B, the left absorbing openings 102aL and the right absorbing openings 102aR each include a plurality of slits 102a1 arranged in a line in the left-right direction. There is no specific limitation on the shape of each of the slits 102a1 of the heating chamber absorbing openings 102a. In this example embodiment, as shown in FIG. 6B, each of the slits 102a1 of the heating chamber absorbing openings 102a has an elongated hole longer in the up-down direction.

Regarding the scanning direction Y, the heating chamber exhaust openings 102b are located below the heating chamber absorbing openings 102a. The left exhaust opening 102bL and the right exhaust opening 102bR are respectively provided in substantially the entirety of the left half and the right half of the body case 51. As shown in FIG. 6B, the left exhaust opening 102bL and the right exhaust opening 102bR also each include a plurality of slits 102b1. There is no specific limitation on the shape of each of the slits 102b1 of the heating chamber exhaust openings 102b. In this example embodiment, as shown in FIG. 6B, each of the slits 102b1 of the heating chamber exhaust openings 102b has an elongated hole longer in the left-right direction.

As shown in FIG. 7A, the plurality of heaters 135 and the plurality of heating chamber fans 132 are provided in the right heating chamber 102R. As shown in FIGS. 7A and 7B, a right thermistor S1R measuring a temperature of the hot air of the right heating chamber 102R is provided in the right heating chamber 102R. In this example embodiment, the left heating chamber 102L has the same configuration as that of the right heating chamber 102R, and is configured to be bilaterally symmetrically with the right heating chamber 102R. Hereinafter, in the case where the left components and the right components are to be distinguished from each other, the heaters 135 in the left heating chamber 102L will be referred to also as “left heaters 135L”, and the heating chamber fans 132 in the left heating chamber 102L will be referred to also as “left fans 132L”. The heaters 135 in the right heating chamber 102R will be referred to also as “right heaters 135R”, and the heating chamber fans 132 in the right heating chamber 102R will be referred to also as “right fans 132R”. A thermistor provided in the left heating chamber 102L will be referred to also as a “left thermistor S1L”. Hereinafter, the configuration of the right heating chamber 102R will be described, and the left heating chamber 102L will not be described because the configuration thereof is substantially the same as that of the right heating chamber 102R. Note that the configuration of the left heating chamber 102L does not need to be the same as that of the right heating chamber 102R.

The right fans 132R take in outside air from the right absorbing openings 102aR of the right heating chamber 102R, and exhausts the air from the right exhaust opening 102bR. As shown in FIG. 7A, the plurality of right fans 132R and the plurality of right heaters 135R are arranged in a line in the scanning direction Y. Note that there may be one right fan 132R and one right heater 135R.

The right heaters 135R heat the air sent by the right fans 132R. There is no specific limitation on the configuration of the right heaters 135R. In this example embodiment, as shown in FIG. 3, the right heaters 135R each include a cylinder 135A and a heating wire (not shown) located inside the cylinder 135A. The air is heated by the heating wire when passing inside the cylinder 135A.

As shown in FIG. 3, the right fans 132R are attached to the partition wall 116. The partition wall 116 has a plurality of openings 116a formed therein, which are arranged in a line in the left-right direction (FIG. 3 shows only one opening 116a). The openings 116a communicate the upstream chamber 102U and the downstream chamber 102D of the heating chamber 102 to each other. The right fans 132R are attached to the openings 116a of the partition wall 116. The right fans 132R take the air into the right heating chamber 102R from the right absorbing openings 102aR, send the air in the upstream chamber 102U to the downstream chamber 102D via the openings 116a, and exhaust the air in the downstream chamber 102D from the right exhaust opening 102bR. The right fans 132R are configured to send the air in the right heating chamber 102R. In this example embodiment, the right fans 132R are each an axial fan. The right exhaust opening 102bR may have a total opening area that is smaller than a cross-sectional area of flow paths of the right fans 132 such that an area that is downstream with respect to the right fans 132R is a pressurized space.

The right thermistor S1R is an example of temperature sensor that measures the temperature of the hot air generated in the right heating chamber 102R. The temperature sensor is not limited to a thermistor, and may be, for example, a thermocouple. The temperature sensor does not need to be housed in the right heating chamber 102R partially or entirely. The temperature sensor does not need to be housed inside the right heating chamber 102R as long as the temperature sensor is capable of measuring the temperature of the hot air at a position away from the right heating chamber 102R (in the case where, for example, the temperature of the hot air is to be measured just outside the right exhaust opening 102bR).

As shown in FIG. 3, the right thermistor S1R is provided in the exit chamber 102E of the right heating chamber 102R. In more detail, the right thermistor S1R is secured to a portion that defines a front wall of the partition wall 117 defining the exit chamber 102E.

As described below in more detail regarding the controller 200, in this example embodiment, the temperature of the hot air in the right heating chamber 102R is controlled based on the measurement performed by the right thermistor S1R, independently from the measurement performed by the left heating chamber 102L. In the case where the control on the temperature of the hot air in the right heating chamber 102R and the control on the temperature of the hot air in the left heating chamber 102L are not to be distinguished from each other, the right thermistor S1R and the left thermistor S1L may collectively be referred to as the “thermistors S1”, and an expression, for example, that “the temperature of the hot air in the heating chamber 102 is measured by the thermistors S1” is used.

The temperature of the hot air in the right heating chamber 102R and the temperature of the hot air in the left heating chamber 102L are controlled independently from each other, so that the amount of heat of the hot air is suppressed from being varied in accordance with the position. The air generated by the heating fans 132 has different volumes between one side and the other wide of the exit. Therefore, in the case where a plurality of fans are provided in one heating chamber 102, the air heated by the heaters 135 is cooled by the heating chamber fans 132 on the side having a large air volume, whereas the air heated by the heaters 135 is not cooled much by the heating chamber fans 132 on the side having a smaller air volume. Therefore, the differences in the amount of heat are added together, and the difference in the amount of heat in accordance with the position in the heating chamber 102 is made large. As a result, the temperatures of the dried air blown out from the heating chamber exhaust openings 102b become non-uniform due to the difference in the amount of heat.

In this example embodiment, the heating chamber 102 is separated into two heating chambers 102L and 102R. The heating chamber 102 may be separated into three or more heating chambers. The inside of the body case 51 may be separated into a plurality of areas including the plurality of heating chambers 102. Note that there may be one heating chamber 102 with no separation into a plurality of heating chambers.

The rear wall 51B is secured to a plurality of brackets 52 shown in FIG. 7A. The brackets 52 are each an example of support portion supporting the rear wall 51B. In this example embodiment, each of the brackets 52 is a flat plate, for example, and as shown in FIG. 7B, extends in the transportation direction X and the scanning direction Y (substantially parallel to the downstream guide 14). The plurality of brackets 52 are arranged in a line in the scanning direction Y. As shown in FIGS. 6A and 6B, the body case 51 includes a plurality of screws 53 securing the rear wall 51B to the plurality of brackets 52.

As shown in FIG. 6B, the rear wall 51B includes screw attachment portions 51B1, to which the screws 53 are respectively attached. The screw attachment portions 51B1 are located to separate the heating chamber absorbing openings 102a in the left-right direction. The screw attachment portions 51B1 each have a hole formed therein, through which the screw 53 is insertable. The screw attachment portions 51B1 are positions at which the heating chamber absorbing openings 102a are separated. In this example embodiment, the plurality of screw attachment portions 51B1 are provided. Note that there may be one screw attachment portion 51B1. The rear wall 51B is secured to the brackets 52 by the screws 53, so that the rear wall 51B is suppressed from vibrating as a result of absorbing the air. However, the screw attachment portions 51B1 prevent the air from being absorbed into the heating chamber 102, and the amount of the absorbed air is decreased in the vicinity of the screw attachment portions 51B1.

In this example embodiment, as shown in FIG. 6B, some portion of the screw attachment portions 51B1 are positionally matched to the corresponding heating chamber fans 132 in the scanning direction Y. The portion of the screw attachment portions 51B1 is located in front of the corresponding heating chamber fan 132 in the scanning direction Y. Such a screw attachment portion 51B1 is located in front of the corresponding heating chamber fan 132, so that the air absorbed by the heating chamber fan 132 is prevented from flowing, and the amount of the air absorbed by the heating chamber fan 132 is decreased. With this arrangement, the amount of the absorbed air in front of the heating chamber fan 132, which would otherwise be larger than the amount of the absorbed air at the other positions, is suppressed. As a result, the amount of the absorbed air generated between the positions in front of the plurality of heating chamber fans 132 and the other positions is suppressed from being unbalanced, and the difference in the amount of the absorbed air in accordance with the positions, in the left-right direction, of the heating chamber absorbing openings 102a is decreased. In this example embodiment, the screw attachment portion 51B1 is not provided in front of each of the heating chamber fans 132 at the left end and the right end. Alternatively, the screw attachment portion 51B1 may be provided in front of all the heating chamber fans 132.

The rear wall 51B of the body case 51 merely needs to include opening portions where the heating chamber absorbing openings 102a are provided and closed portions where the heating chamber absorbing openings 102a are not provided and to face the recording medium 5. The closed portions merely need to be located at positions matching the positions of the heating chamber fans 132 in the scanning direction Y. The closed portions are the screw attachment portions 51B1 in this example embodiment, but do not need to be the screw attachment portions 51B1. The closed portions may be simply, for example, portions where the heating chamber absorbing openings 102a are not provided.

The heating chamber 102 extends in the left-right direction, and the heating chamber exhaust openings 102b are located in the entirety thereof in the left-right direction. The heating chamber fans 132 are located in a dispersed manner in the left-right direction. Therefore, a rectifier uniformizing the speed distribution of the air exhausted from the heating chamber exhaust openings 102b may be provided. In this example embodiment, the rectifier plate 127 is located in the downstream chamber 102D of the heating chamber 102. As the rectifier plate 127, a punching metal, for example, may be preferably used. The rectifier plate 127 extends in the left-right direction, and extends in the entirety of the body case 51 in the left-right direction. It is preferred that the rectifier plate 127 is located at a position close to the heating chamber exhaust openings 102b in order to improve the effect of the rectification. Note that there is no specific limitation on the position of the rectifier plate 127. In this example embodiment, the through-hole 127h of the rectifier plate 127 has a total opening area larger than a total opening area of the heating chamber exhaust openings 102b, although the relationship between the total opening areas is not limited to this.

The air blowing chamber 101 and first air blowing fans 131A housed in the air blowing chamber 101 generate air for the initial air blowing. The air blowing chamber 101 and second air blowing fans 131B housed in the air blowing chamber 101 generate air that prevents the hot air, generated by the heaters 135 and the heating chamber fans 132, from moving to the platen 16 (such air is referred to also as an “air curtain”). Hereinafter, a configuration generating the air for the initial air blowing (the air blowing chamber 101 and the first air blowing fans 131A) will be referred to also as an “initial air blowing device 101P”. A configuration generating the air curtain and thus preventing the hot air, generated by the heating chamber fans 132, from flowing to the platen 16 (the air blowing chamber 101 and the second air blowing fans 131B) will be referred to also as an “air curtain device 101C”.

As shown in FIG. 3, the drying device 50 includes a partition wall 114 separating the inside of the air blowing chamber 101 into a first air blowing chamber 121 and a second air blowing chamber 122. The drying device 50 further includes an attachment plate 115 separating an air absorbing chamber 123 from the first air blowing chamber 121 and the second air blowing chamber 122. As shown in FIG. 4, the top wall 51U of the body case 51 has air blowing chamber absorbing openings 101a formed therein. The air blowing chamber absorbing openings 101a communicate the outside of the body case 51 and the air absorbing chamber 123 to each other. The plurality of air blowing chamber absorbing openings 101a are provided and are arranged in a line in the left-right direction.

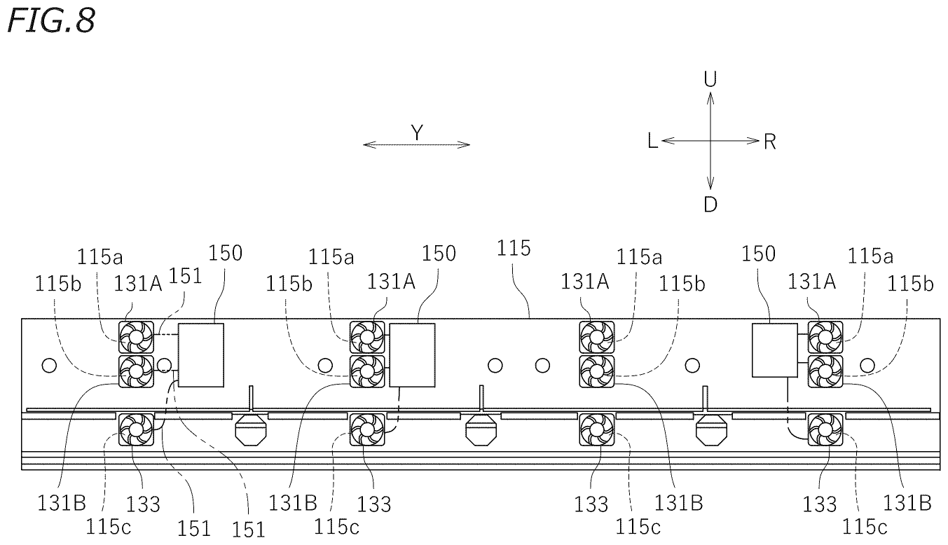

FIG. 8 is a front view of the attachment plate 115. As shown in FIG. 8, the attachment plate 115 is a flat plate extending in the left-right direction and the up-down direction. The attachment plate 115 has a plurality of first openings 115a arranged in a line in the left-right direction, a plurality of second openings 115b arranged in a line in the left-right direction, and a plurality of third openings 115c arranged in a line in the left-right direction formed therein. The first openings 115a, the second openings 115b and the third openings 115c are respectively arranged in the up-down direction. In this example embodiment, the second openings 115b are respectively located just below the first openings 115a, and the third openings 115c are respectively located just below the second openings 115b. The first openings 115a, the second openings 115b and the third openings 115c are opened in the front-rear direction.

As shown in FIG. 3, the drying device 50 includes the plurality of first air blowing fans 131A and the plurality of second air blowing fans 131B provided in the air blowing chamber 101, and a plurality of non-heating chamber fans 133 provided in the non-heating chamber 103. The first air blowing fans 131A and the second air blowing fans 131B are located in the air absorbing chamber 123 in the air blowing chamber 101.

As shown in FIG. 8, the first air blowing fans 131A, the second air blowing fans 131B and the non-heating chamber fans 133 are attached to the attachment plate 115. The plurality of first air blowing fans 131A are arranged in a line in the left-right direction, the plurality of second air blowing fans 131B are arranged in a line in the left-right direction, and the plurality of non-heating chamber fans 133 are arranged in a line in the left-right direction. The first air blowing fans 131A, the second air blowing fans 131B and the non-heating chamber fans 133 are arranged in a line in the up-down direction. The second air blowing fans 131B are respectively located just below the first air blowing fans 131A, and the non-heating chamber fans 133 are respectively located just below the second air blowing fans 131B. The first air blowing fans 131A, the second air blowing fans 131B and the non-heating chamber fans 133 are located parallel to each other so as to send air rearward in a horizontal direction. In this example embodiment, the first air blowing fans 131A, the second air blowing fans 131B and the non-heating chamber fans 133 are each an axial fan.

The first openings 115a of the attachment plate 115 communicate the air absorbing chamber 123 and the first air blowing chamber 121 to each other. The first air blowing fans 131A are attached to the first openings 115a of the attachment plate 115. The first air blowing fans 131A take the air into the air absorbing chamber 123 from the air blowing chamber absorbing openings 101a, and send the air in the air absorbing chamber 123 to the first air blowing chamber 121 via the first openings 115a. The first air blowing fans 131A are located so as to send the air rearward in the horizontal direction.

The second openings 115b of the attachment plate 115 communicate the air absorbing chamber 123 and the second air blowing chamber 122 to each other. The second air blowing fans 131B are attached to the second openings 115b of the attachment plate 115. The second air blowing fans 131B take the air into the air absorbing chamber 123 from the air blowing chamber absorbing openings 101a, and send the air in the air absorbing chamber 123 to the second air blowing chamber 122 via the second openings 115b. The second air blowing fans 131B are located so as to send the air rearward in the horizontal direction.

In this example embodiment, the first air blowing fans 131A and the second air blowing fans 131B are respectively located as being shifted from positions just below the air blowing chamber absorbing openings 101a. The first air blowing fans 131A and the second air blowing fans 131B are respectively located to the left of, or to the right of, the air blowing chamber absorbing openings 101a (see FIG. 4). With this arrangement, even if foreign substances are absorbed from the air blowing chamber absorbing openings 101a, it is highly possible that the foreign substances fall to positions shifted, in the left-right direction, from the first air blowing fans 131A and the second air blowing fans 131B. Therefore, the foreign substances are prevented from being caught in the first air blowing fans 131A or the second air blowing fans 131B. A malfunction of the first air blowing fans 131A and the second air blowing fans 131B caused by catching the foreign substances therein is prevented.

As shown in FIG. 3, a first air blowing chamber nozzle 121b and a second air blowing chamber nozzle 122N are formed above the rear wall 51B. The first air blowing chamber nozzle 121b and the second air blowing chamber nozzle 122N are respectively exhaust openings of the first air blowing chamber 121 and the second air blowing chamber 122. The first air blowing chamber nozzle 121b communicates the first air blowing chamber 121 and the outside of the body case 51 to each other. The second air blowing chamber nozzle 122N communicates the second air blowing chamber 122 and the outside of the body case 51 to each other. The second air blowing chamber nozzle 122N is located below the first air blowing chamber nozzle 121b. The second air blowing chamber nozzle 122N is located above the heating chamber absorbing openings 102a. The first air blowing chamber nozzle 121b and the second air blowing chamber nozzle 122N are located to the rear of the heating chamber exhaust openings 102b.

As shown in FIG. 6A, the first air blowing chamber nozzle 121b and the second air blowing chamber nozzle 122N are formed in the entirety of the body case 51 in the left-right direction. As shown in FIG. 3, the first air blowing chamber 121 has an exhaust flow path 121A formed therein, which has a width in the up-down direction decreasing as extending rearward. The first air blowing chamber nozzle 121b is connected with the exhaust flow path 121A. The first air blowing chamber nozzle 121b is opened toward the platen 16. In this example embodiment, the first air blowing chamber nozzle 121b is opened rearward in the horizontal direction. The first air blowing fans 131A exhaust the air in the first air blowing chamber 121 from the first air blowing chamber nozzle 121b. The first air blowing fans 131A are configured to send the air in first air blowing chamber 121. A rectifier plate 125 is provided between the exhaust flow path 121A and the first air blowing fans 131A. The first air blowing chamber 121 and the plurality of first air blowing fans 131A form the initial air blowing device 101P.

The second air blowing chamber 122 includes an air blowing path 122A, in which the air flows. The second air blowing chamber nozzle 122N is an exit of the air of the air blowing path 122A. The second air blowing chamber nozzle 122N is a nozzle from which the air generated by the second air blowing fans 131B is jetted out. The air jetted out from the second air blowing chamber nozzle 122N acts as an air curtain preventing the hot air from moving to the platen 16. As shown in FIG. 6B, the second air blowing chamber nozzle 122N extends in the left-right direction. The second air blowing chamber nozzle 122N is provided in the entirety of the body case 51 in the left-right direction. The second air blowing chamber nozzle 122N is opened rearward and downward toward a top wall 14U of the downstream guide 14. As shown in FIG. 3, the second air blowing chamber nozzle 122N is provided beyond the heating chamber absorbing openings 102a in the upstream direction X2 of the transportation direction X.

The first air blowing fans 131A and the second air blowing fans 131B may be of the same specifications as each other, or may be of different specifications from each other. The volumes of the air blown by the first air blowing fans 131A and the second air blowing fans 131B may be the same as each other or may be different from each other. In this example embodiment, the first air blowing fans 131A and the second air blowing fans 131B are set such that the speed at which the air is blown from the second air blowing chamber nozzle 122N is higher than the speed at which the air is blown from the first air blowing chamber nozzle 121b. A rectifier plate 126 is provided between the second air blowing chamber nozzle 122N and the second air blowing fans 131B.

As shown in FIG. 3, the second air blowing chamber nozzle 122N includes a bottom nozzle plate 122N1 and a top nozzle plate 122N2 each extending in the scanning direction Y (see FIG. 6B) and arranged in the transportation direction X. In this example embodiment, the bottom nozzle plate 122N1 and the top nozzle plate 122N2 are parallel or substantially parallel to each other, and extend rearward and downward so as to cross the downward guide 14 perpendicularly or substantially perpendicularly. The second air blowing fans 131B exhaust the air in the second air blowing chamber 122 from the second air blowing chamber nozzle 122N. The air generated by the second air blowing fans 131B is jetted out between the bottom nozzle plate 122N1 and the top nozzle plate 122N2.

As shown in FIG. 3, a plurality of spacers 128 are sandwiched between the bottom nozzle plate 122N1 and the top nozzle plate 122N2 (see also FIGS. 6A and 6B). The spacers 128 are sandwiched between the bottom nozzle plate 122N1 and the top nozzle plate 122N2. The spacers 128 are sandwiched between the bottom nozzle plate 122N1 and the top nozzle plate 122N2, so as to guarantee that a certain length of interval is provided between the bottom nozzle plate 122N1 and the top nozzle plate 122N2. As shown in FIG. 6B, the plurality of spacers 128 are arranged in a line in the scanning direction Y. Note that there may be one spacer 128.

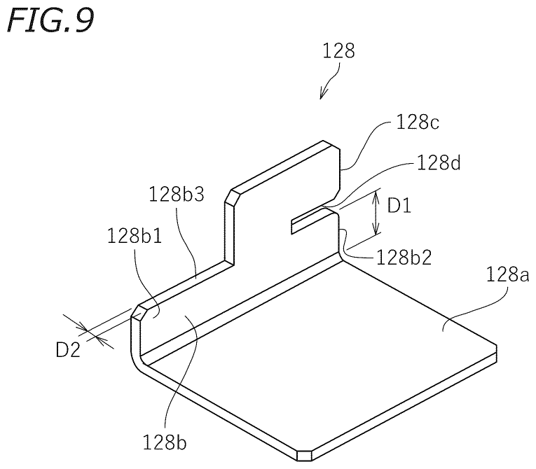

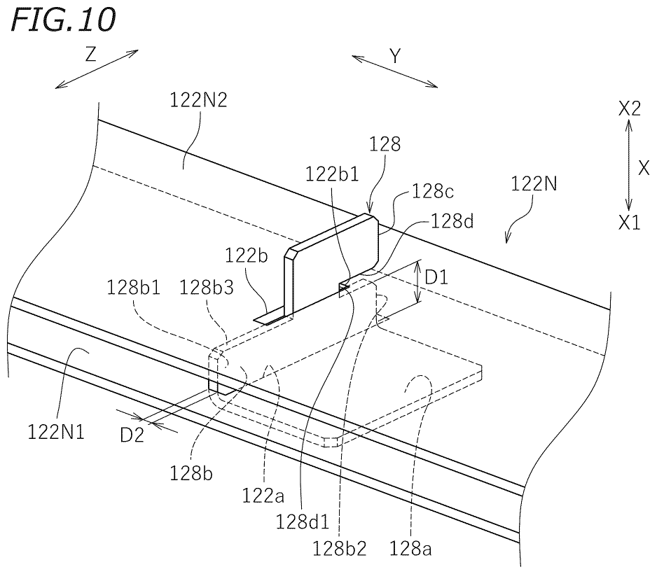

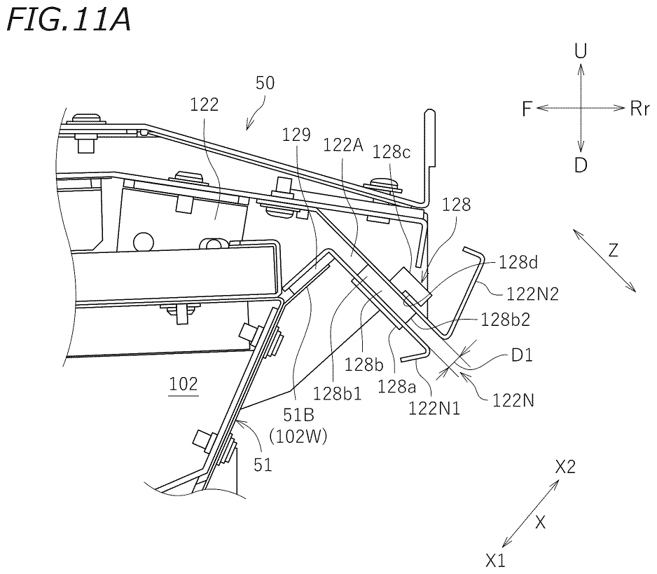

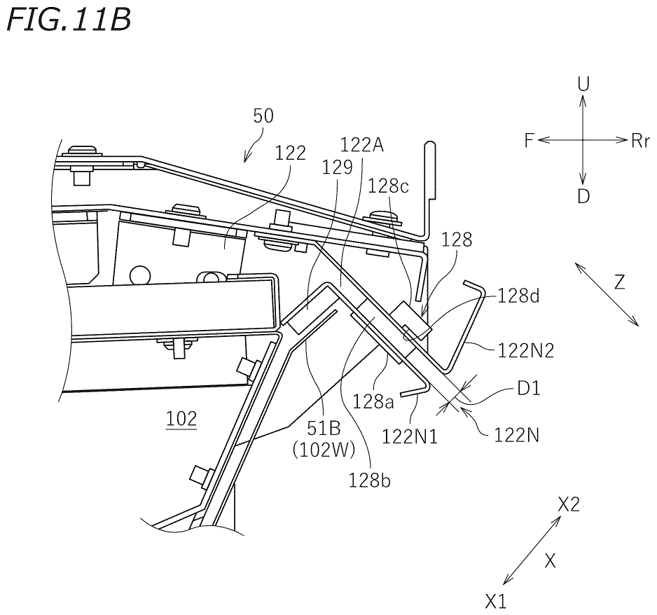

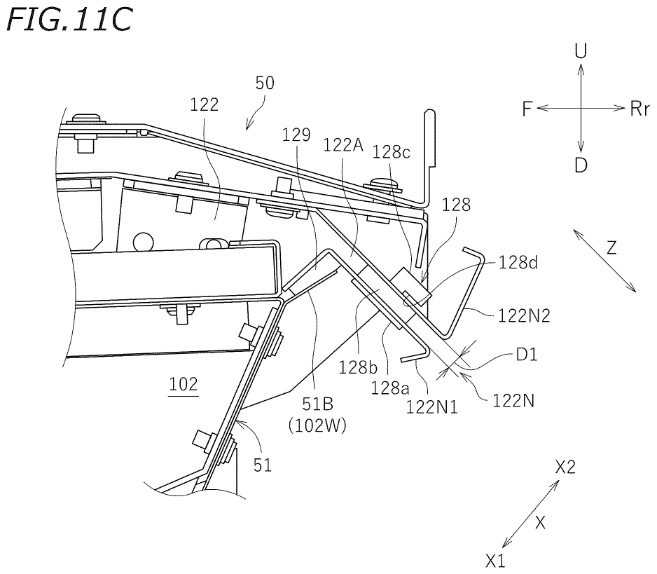

FIG. 9 is a perspective view of the spacer 128. FIG. 10 is a perspective view showing the second air blowing chamber nozzle 122N in a state where the spacer 128 is sandwiched. FIG. 11A is a cross-sectional view of the area in the vicinity of the border between the heating chamber 102 and the second air blowing chamber nozzle 122N. As shown in FIG. 9 and FIG. 10, the spacer 128 includes a connection portion 128a secured to the bottom nozzle plate 122N1, a plate-shaped support portion 128b extending from the connection portion 128a toward the top nozzle plate 122N2 (in this example embodiment, in the transportation direction X), an extending portion 128c connected with the support portion 128b and extending beyond the top nozzle plate 122N2, and a cut-in portion 128d formed at a border between the support portion 128b and the extending portion 128c and running through the spacer 128 in a thickness direction thereof (in this example embodiment, in the scanning direction Y). The connection portion 128a is a plate extending parallel to the bottom nozzle plate 122N1, and is in planar contact with the bottom nozzle plate 122N1. In this example embodiment, the connection portion 128a is welded to the bottom nozzle plate 122N1. Note that there is no specific limitation on the method for securing the connection portion 128a and the bottom nozzle plate 122N1 to each other.

The support portion 128b is located between the bottom nozzle plate 122N1 and the top nozzle plate 122N2, and supports the top nozzle plate 122N2. As shown in FIG. 10, the support portion 128b is a flat plate including a main plane 128b1 and a narrow plane 128b2 narrower than the main plane 128b1. The narrow plane 123b2 faces a transportation path of the recording medium 5 (in this example embodiment, the downstream guide 14). The support portion 128b is provided such that a thickness direction thereof (width direction of the narrow plane 128b2) is perpendicular to the transportation direction X. In this example embodiment, the main plane 128b1 extends in the transportation direction X and a third direction perpendicular to the transportation direction X and the scanning direction (hereinafter, the third direction will be referred to also as a “Z direction”) (see also FIG. 3 and FIG. 11A). The narrow plane 123b2 extends in the transportation direction X and the scanning direction Y.

The support portion 128b is a plate that extends in the Z direction and is thin in the scanning direction Y, so that the spacers 128 inhibit the flow of the air less than in the case where the support portion 128b is configured to be wide in the scanning direction Y. Note that the support portion 128b may be located such that the main plane 128b1 slightly inclines with respect to the Z direction, or such that the main plane 128b1 slightly inclines with respect to the transportation direction X. A thickness D2 of the support portion 128b in the scanning direction Y (the width of the narrow plane 128b2) is preferably about 3.2 mm or less, for example. The thickness D2 of the support portion 128b is more preferably about 1 mm or less, for example. The thickness D2 of the support portion 128b is, for example, about 0.8 mm.

The support portion 128b includes a placed portion 128b3 away, by a predetermined distance D1, from the connection portion 128a in the transportation direction X. On the placed portion 128b3, the top nozzle plate 122N is placed. The placed portion 128b3 is a top edge of the support portion 128b. The predetermined distance D1 is set to be equal to an interval between the bottom nozzle plate 122N1 and the top nozzle plate 122N2. The top nozzle plate 122N2 is placed on the placed portion 128b3, so as to be held away from the bottom nozzle plate 122N1 by the distance D1 (see also FIG. 11A). In this example embodiment, the support portion 128b and the top nozzle plate 122N2 are secured to each other by welding. Note that there is no specific limitation on the method for securing the support portion 128b and the top nozzle plate 122N2 to each other.

The cut-in portion 128d is formed at the border between the support portion 128b and the extending portion 128c, and runs through the spacer 128 in the thickness direction. The cut-in portion 128d is spaced away from a top surface of the connection portion 128a by the distance D1 in the transportation direction X, which is equal to the distance from the placed portion 128b3 to the top surface of the connection portion 128a. The cut-in portion 128d extends through the support portion 128b in the scanning direction Y, and extends parallel or substantially parallel to the placed portion 128b3. The top nozzle plate 122N2 is inserted into the cut-in portion 128d.

As shown in FIG. 10, the bottom nozzle plate 122N1 has a first through-hole 122a formed therein, through which the support portion 128b is insertable. The support portion 128b is inserted through the first through-hole 122a. The first through-hole 122a has a thickness corresponding to the thickness D2 of the support portion 128b in the scanning direction Y and also having a length corresponding to a length of the support portion 128b in the Z direction. The first through-hole 122a extends in the Z direction. For producing the second air blowing chamber nozzle 122N, the support portion 128b is inserted into the first through-hole 122a from below and then is welded to the bottom nozzle plate 122N. At the time of welding, the connection portion 128a is attached to a bottom surface of the bottom nozzle plate 122N1. As a result, the distance of the placed portion 128b3 and the cut-in portion 128d from the bottom nozzle plate 122N1 is determined to be the distance D1, and the direction in which the placed portion 128b3 and the cut-in portion 128d extend is determined to be the Z direction. In addition, the positions of the placed portion 128b3 and the cut-in portion 128d in the Z direction are determined.

The top nozzle plate 122N2 has a second through-hole 122b formed therein, through which the extending portion 128c of the spacer 128 is insertable. The extending portion 128c is inserted through the second through-hole 122b. The second through-hole 122b has a width corresponding to the thickness D2 of the support portion 128b and a length in the Z direction that is longer than a length of the extending portion 128c in the Z direction. The second through-hole 122b extends in the Z direction. The top nozzle plate 122N2 is inserted into the cut-in portion 128d such that an edge 122b1 of the second through-hole 122b on one side of the Z direction (in this example embodiment, a bottom edge of the second through-hole 122b) and an edge of the cut-in portion 128d on the other side of the Z direction (in this example embodiment, a top edge of the cut-in portion 128d) contact each other. With this arrangement, the position of the top nozzle plate 122N2 in the Z direction is determined.

From a state where the extending portion 128c is inserted through the second through-hole 122b, the top nozzle plate 122N2 is slid such that the edge 122b1 on the rear side of the second through-hole 122b bumps against an edge of the cut-in portion 128d on a deeper side in the direction in which the second through-hole 122b extends (in this example embodiment, an edge 128d1 on a forward side), and as a result, the top nozzle plate 122N2 is inserted into the cut-in portion 128d. The support portion 128b is configured such that the length thereof in the sliding direction (Z direction) is longer than a length of the second through-hole 122b in the sliding direction (Z direction). As shown in FIG. 10, after the top nozzle plate 122N2 is slid, a portion of the second through-hole 122b is closed by the extending portion 128c being inserted through the second through-hole 122b. The remaining portion of the second through-hole 122b is closed by the support portion 128b.

Such a configuration of the spacer 128 may be applied to another nozzle, for example, the first air blowing chamber nozzle 121b. In the case where, for example, the heating chamber exhaust openings 102b are each configured to be like a nozzle, the configuration of the spacer 128 may be applied to the heating chamber exhaust openings 102b.

In this example embodiment, as shown in FIG. 6B, the plurality of spacers 128 are located so as to be positionally shifted in the left-right direction with respect to the plurality of heating chamber fans 132. Therefore, the plurality of spacers 128 are positionally shifted in the left-right direction also with respect to the plurality of screw attachment portions 51B1. Regarding the left-right direction, at the positions where the screw attachment portions 51B1 are present, the amount of the air absorbed by the heating chamber fans 132 is decreased, and therefore, high-temperature air stagnates. Portions, of the heating chamber absorbing openings 102a, that are separated by the screw attachment portions 51B1 are in front of the heating chamber fans 132 and normally absorb a large amount of the air. Therefore, the amount of heat stagnating in such portions is small even if the screw attachment portions 51B1 are present. However, if the spacers 128 positionally match the screw attachment portions 51B1 in the left-right direction, the spacers 128 block the air from the second air blowing chamber nozzle 122N and the screw attachment portions 51B1 block the air absorption. For these reasons, the heat easily stagnates in front of the spacers 128. If an excessive amount of heat stagnates between the drying device 50 and the recording medium 5 on the downstream guide 14, a problem that, for example, the recording medium 5 is wrinkled easily occurs. Therefore, in this example embodiment, the plurality of spacers 128 and the plurality of heating chamber fans 132 are located to be positionally shifted from each other in the left-right direction.

In this example embodiment, as shown in FIG. 11A, the wall forming the bottom nozzle plate 122N1 is bent downward at a base of the second air blowing nozzle 122N, and the bent portion overlaps a top portion of the rear wall 51B of the heating chamber 102. The bottom nozzle plate 122N1 is one of walls defining the air blowing path 122A of the second air blowing chamber 122, and faces a portion of the rear wall 51B. The air blowing path 122A of the second air blowing chamber 122 is located adjacent to the rear wall 51B. As shown in FIG. 11A, a plate-shaped sponge 129 is sandwiched between a portion of the rear wall 51B (heating chamber wall 102W) and a portion of the bottom nozzle plate 122N1 overlapping each other. FIG. 11B is a cross-sectional view of an area in the vicinity of the border between the heating chamber 102 and the second air blowing chamber nozzle 122N before the sponge 129 is sandwiched between the rear wall 51B and the bottom nozzle plate 122N1. As shown in FIGS. 11A and 11B, the sponge 129 is compressed by the rear wall 51B and the bottom nozzle plate 122N1. The sponge 129 is an example of deformation member that is sandwiched in a compressed state between the rear wall 51B and the bottom nozzle plate 122N1 and is restored in accordance with the distance between the rear wall 51B and the bottom nozzle plate 122N1. The deformation member is not limited to a sponge-shaped foaming member, and may be, for example, a plate-shaped rubber member or the like.

The heating chamber wall 102W is heated by the heaters 135. Therefore, the heating chamber wall 102W (in this example embodiment, the rear wall 51B) expands by the heat and is warped. FIG. 11C is a cross-sectional view of the area in the vicinity of the border between the heating chamber 102 and the second air blowing chamber nozzle 122N in a state where the rear wall 51B is deformed by the heat. As shown in FIG. 11C, the deformation of the rear wall 51B increases the interval between the rear wall 51B and the bottom nozzle plate 122N1. Even when the interval increases, the sponge 129 in a compressed state is restored in accordance with the increase in the interval. In this manner, the sponge 129 prevents a gap from being formed between the rear wall 51B and the bottom nozzle plate 122N1. As a result, the heating chamber 102 and the air blowing path 122A of the second air blowing chamber 122 are sealed to separate the air blowing path 122A and the heating chamber 102 from each other. The air blowing path 122A and the heating chamber 102 are separated from each other, so that the air having a relatively low temperature that flows inside the air blowing path 122A is suppressed from being absorbed into the heating chamber absorbing openings 102a. With this arrangement, the hot air exhausted from the heating chamber exhaust openings 102b is guaranteed to have a certain level of temperature.

In this example embodiment, the heating chamber absorbing openings 102a are located closer to the bottom nozzle plate 122N1 than the heating chamber exhaust openings 102b. The temperature of the hot air in the drying device 50 is maintained by the air having a high temperature that is exhausted from the heating chamber exhaust openings 102b being absorbed from the heating chamber absorbing openings 102a. In this example embodiment, the heating chamber absorbing openings 102a are located close to the bottom nozzle plate 122N1. Therefore, when a gap is formed between the rear wall 51B and the bottom nozzle plate 122N1, the air having a relatively low temperature that flows in the air blowing path 122A of the second air blowing chamber 122 is absorbed into the heating chamber absorbing openings 102a, and the temperature of the hot air is easily decreased. The sponge 129 suppresses such a decrease in the temperature of the hot air in the drying device 50.

The air blowing path 122A of the second air blowing chamber 122 has an airtightness thereof increased, so that the air curtain jetted out from the second air blowing chamber nozzle 122N is guaranteed to have a certain level of speed. In this example embodiment, the bottom nozzle plate 122N1 forming the second air blowing chamber nozzle 122N overlaps the rear wall 51B, which is a portion of the heating chamber walls 102W, via the sponge 129. Therefore, if a gap is formed between the rear wall 51B and the bottom nozzle plate 122N1, the speed of the air of the air curtain jetted out from the second air blowing chamber nozzle 122N is easily decreased. The sponge 129 suppresses such a decrease in the speed of the air of the air curtain.

As a material of the deformation member, for example, a foaming material of EPDM or the like is preferably usable. It is preferred that the deformation member is a foaming material having an independent cell configuration. The foaming material having the independent cell configuration is restored to an original shape thereof more easily, and is more repulsive, than a foaming material having a continuous cell configuration, and therefore, is appropriate as a material of the deformation member used to guarantee that the air blowing path 122A and the heating chamber 102 have a certain level of airtightness. In addition, a foaming material having the independent cell configuration has the cells thereof not connected with each other, and therefore, prevents, more strictly, the air from being leaked than a foaming material having the continuous cell configuration. Therefore, it guarantees a certain level of airtightness. It is preferred that the material of the deformation member is highly heat-resistant (e.g., is usually used at a temperature of 100 degrees or higher) and has an appropriate level of hardness.

In this example embodiment, the rear wall 51B and the bottom nozzle plate 122N1 are not secured to each other. The rear wall 51B is pressed against the bottom nozzle plate 122N1 by an elastic force of the rear wall 51B via the sponge 129 therebetween. Note that the rear wall 51B and the bottom nozzle plate 122N1 may be secured to each other by, for example, a screw or the like. Even if the rear wall 51B and the bottom nozzle plate 122N1 are partially secured to each other by a screw or the like, sandwiching the sponge 128 between the rear wall 51B and the bottom nozzle plate 122N1 to fill the gap therebetween is effective to seal the heating chamber 102 and the air blowing path 122A. Even in the case where the rear wall 51B and the bottom nozzle plate 122N1 are secured to each other, the gap therebetween may undesirably be slightly expanded by the heat. Therefore, sandwiching the sponge 129 between the rear wall 51B and the bottom nozzle plate 122N1 is effective. In the case where the rear wall 51B and the bottom nozzle plate 122N1 are secured to each other, the rear wall 51B and the bottom nozzle plate 122N1 apply forces to each other by thermal expansion, which applies load on both of the rear wall 51B and the bottom nozzle plate 122N1. This is suppressed by an arrangement in which the rear wall 51B and the bottom nozzle plate 122N1 are not secured to each other. In addition, the sponge 129 seals the heating chamber 102 and the air blowing path 122A.

As shown in FIG. 5, the front wall 51F of the body case 51 has the non-heating chamber absorbing openings 103a formed therein. As shown in FIG. 3, the front wall 51F includes a vertical wall 51FA and an inclining wall 51FB extending rearward and downward from a bottom end of the vertical wall 51FA. In this example embodiment, the non-heating chamber absorbing openings 103a are provided in the inclining wall 51FB. The bottom wall 51D of the body case 51 has non-heating chamber exhaust openings 103b formed therein. In this example embodiment, the bottom wall 51D extends rearward and downward. The non-heating chamber absorbing openings 103a and the non-heating chamber exhaust openings 103b each communicate the outside of the body case 51 and the non-heating chamber 103 to each other. The non-heating chamber absorbing openings 103a are at the front of the non-heating chamber exhaust openings 103b. The non-heating chamber exhaust openings 103b runs through the inclining wall 51FB extending rearward and downward, and therefore, are opened forward and downward.

The non-heating chamber fans 133 are attached to the third openings 115c of the attachment plate 115. The non-heating chamber fans 133 take the air into the non-heating chamber 103 from the non-heating chamber absorbing openings 103a, send the air in the non-heating chamber 103 from a front position toward a rear position of the attachment plate 115 via the third openings 115c, and exhaust the air from the non-heating chamber exhaust openings 103b. The non-heating chamber fans 133 are configured to send the air in the non-heating chamber 103. The non-heating chamber fans 133 may be located at positions overlapping the non-heating chamber absorbing openings 103a as seen in a front view, but in this example embodiment, are located at positions shifted from the non-heating chamber absorbing openings 103a. The non-heating chamber fans 133 are respectively located to the left of, or to the right of, the non-heating chamber absorbing openings 103a. With this arrangement, in the case where foreign substances are absorbed from the non-heating chamber absorbing openings 103a, the foreign substances are prevented from being caught in the non-heating chamber fans 133, and a malfunction of the non-heating chamber fans 133 is prevented.

As shown in FIG. 8, the drying device 50 includes printed circuit boards 150 connected with the first air blowing fans 131A, the second air blowing fans 131B and the non-heating chambers 133 via electric cables 151. The printed circuit boards 150 supply electricity to the first air blowing fans 131A, the second air blowing fans 131B and the non-heating chamber fans 133. There may be one printed circuit board 150. In this example embodiment, the drying device 50 includes the plurality of printed circuit boards 150 arranged in a line in the left-right direction. The printed circuit boards 150 are attached to the attachment plate 115. That is, the printed circuit boards 150, the first air blowing fans 131A, the second air blowing fans 131B and the non-heating chamber fans 133 are commonly attached to the attachment plate 115. In the case where the printed circuit boards 150 are respectively located in the vicinity of the first air blowing fans 131A, the second air blowing fans 131B and the non-heating chamber fans 133, the electric cables 151 connecting the first air blowing fans 131A, the second air blowing fans 131B and the non-heating chamber fans 133 to the printed circuit boards 150 each have a shortened length, which is preferred. The printed circuit boards 150 are located in the air absorbing chamber 123 of the air blowing chamber 101. In the air absorbing chamber 123, an air flow is generated by the first air blowing fans 131A and the second air blowing fans 131B. The printed circuit boards 150 are cooled by the above-mentioned air flow. Note that there is no specific limitation on the positions of the printed circuit boards 150. The printed circuit boards 150 may be located in the non-heating chamber 103. In this case, the printed circuit boards 150 are cooled by the air flow formed by the non-heating chamber fans 133.

In this example embodiment, the partition wall 112 and the partition wall 114 are formed of iron. The partition wall 111 and the partition wall 113 separating the inside of the heating chamber 102 are formed of stainless steel. The partition wall 111 and the partition wall 113 each have a thermal conductivity that is lower than that of each of the partition wall 112 and the partition wall 114. In addition, heat insulators 155 are provided on the side of the air blowing chamber 101 with respect to the partition wall 111 and on the side of the non-heating chamber 103 with respect to the partition wall 113, in order to further suppress the heat in the heating chamber 102 from being transmitted to the air blowing chamber 101 and the non-heating chamber 103. In this example embodiment, the heat insulators 155 are flexible and easily deformable.

The attachment plate 115 is pressed against the heat insulators 155 from the front. The attachment plate 115 is pressed against the partition wall 111 and the partition wall 113 while having the heat insulators 155 therebetween. The attachment plate 115 is pressed against the partition wall 111 and the partition wall 113, so as to be positioned at a predetermined position. The heat insulators 155 are present between the attachment plate 115 and the partition wall 111 and between the attachment plate 115 and the partition wall 113. This suppresses the printed circuit boards 150, the first air blowing fans 131A, the second air blowing fans 131B and the non-heating chamber fans 133 attached to the attachment plate 115 from being heated by the heat of the heating chamber 102.

Note that there is no specific limitation on the material of the partition wall 111 or the partition wall 113. The heat insulators 155 are not absolutely necessary, and may be omitted.

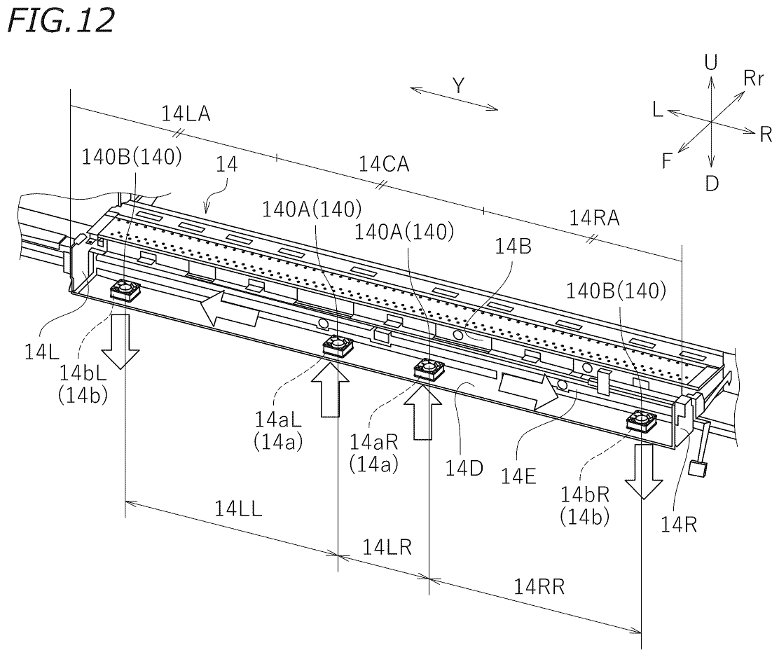

Now, the downstream guide 14 will be described. In this example embodiment, the downstream guide 14 includes a top member 18 and a bottom member 15. In this example embodiment, the downstream guide 14 is adjacent to the platen 16 at a position downstream, in the transportation direction X, with respect to the platen 16. As shown in FIG. 3, a case 14X of the downstream guide 14 includes the top wall 14U extending forward and downward. The case 14X of the downstream guide 14 extends in the left-right direction. FIG. 12 is a perspective view of the downstream guide 14, with the top wall 14U and the bottom member 15 not being shown. The downstream guide 14 includes a rear wall 14B, a bottom wall 14D extending rearward from the top wall 14U, the top wall 14U, a left wall 14L located to the left of the rear wall 14B and the bottom wall 14D, and a right wall 14R located to the right of the top wall 14U, the rear wall 14B and the bottom wall 14D.

The bottom wall 14D has inlet openings 14a and outlet openings 14b formed therein. The top wall 14U, the rear wall 14B, the bottom wall 14D, the left wall 14L and the right wall 14R define air flow paths 14E directed from the inlet openings 14a toward the outlet openings 14b. The inlet openings 14a are formed in a center portion 14CA provided as a result of the downstream guide 14 being equally divided into three in the left-right direction. There may be one inlet opening 14a or the plurality of inlet openings 14a. In this example embodiment, two inlet openings 14a are formed. The inlet openings 14a include a left inlet opening 14aL and a right inlet opening 14aR formed to the right of the left inlet opening 14aL. There may be one outlet opening 14b or the plurality of outlet openings 14b. In this example embodiment, two outlet openings 14b are formed. The outlet openings 14b include a left outlet opening 14bL and a right outlet opening 14bR. The left outlet opening 14bL and the right outlet opening 14bR are respectively formed in a left portion 14LA and a right portion 14RA, which are provided as a result of the downstream guide 14 being equally divided into three in the left-right direction. A distance 14LR between centers of the left inlet opening 14aL and the right inlet opening 14aR is shorter than a distance 14LL between the center of the left inlet opening 14aL and a center of the left outlet opening 14bL, and is shorter than a distance 14RR between the center of the right inlet opening 14aR and a center of the right outlet opening 14bR.

The downstream guide 14 has cooling fans 140 attached thereto, which cause air to flow to the air flow paths 14E, such that the air absorbed from the inlet openings 14a flows in the air flow paths 14E and flows out from the outlet openings 14b. The cooling fans 140 play a role of causing the air to flow to the air flow paths 14E defined by the top wall 14U to cool the top wall 14U. In this example embodiment, the cooling fans 140 include absorbing fans 140A connected with the inside of the downstream guide 14 and the inlet openings 14a and exhaust fans 140B connected with the inside of the downstream guide 14 and the outlet openings 14b. The absorbing fans 140A absorb the air outside the downstream guide 14 into the air flow paths 14E from below. The exhaust fans 140B exhaust the air in the air flow path 14E downward to the outside of the downstream guide 14. In this example embodiment, the absorbing fans 140A and the exhaust fans 140B are each an axial fan.

It is preferred that the downstream guide 14 is formed of a material having a low thermal conductivity. Alternatively, a material having a high thermal conductivity may be used together with a heat insulator. The top wall 14U, the rear wall 14B, the bottom wall 14D, the left wall 14L and the right wall 14R may be formed of, for example, stainless steel, or may be an iron plate having a heat insulator pasted thereto.

As shown in FIG. 3, the printer 10 includes a medium sensor S2 to sense the recording medium 5 when the recording medium 5 reaches a predetermined position that is beyond the drying device 50 in the upstream direction X2 of the transportation direction X. In this example embodiment, the predetermined position is set to a most upstream position of the downstream guide 14. Note that the medium sensor S2 is not limited to sensing the recording medium 5 when the recording medium 5 reaches the most upstream position of the downstream guide 14. The medium sensor S2 may sense the recording medium 5 when the recording medium 5 reaches any position that is on the platen 16 or on the downstream guide 14 and is beyond the drying device 50 in the upstream direction X2 of the transportation direction X. For example, the medium sensor S2 may sense the recording medium 5 when the recording medium 5 reaches a most downstream position of the platen 16. There is no specific limitation on the type of the medium sensor S2. In this example embodiment, the medium sensor S2 is an optical sensor. The medium sensor S2 may further be configured to sense a rise of the recording medium 5 from the downstream guide 14 or from the platen 16 at a predetermined position. For sensing the rise of the recording medium 5, any of various known methods is usable with no specific limitation.

FIG. 13 is a control block diagram of the printer 10. As shown in FIG. 13, the controller 200 is connected with the operation panel 12, the first driving motor 24 of the head moving device 31, the second driving motor 27 of the transporter 32, the ink head 35, the cutter driving portion 42 of the sheet cutter 40, and the first air blowing fans 131A, the second air blowing fans 131B, the heating chamber fans 132 (the left fans 132L and the right fans 132R), the non-heating chamber fans 133 and the heaters 135 (the left heaters 135L and the right heaters 135R) of the drying device 50, and is configured or programmed to control operations thereof. The controller 200 is connected with the thermistors S1 (the left thermistor S1L and the right thermistor S1R) and the medium sensor S2, and receive signals therefrom.

There is no specific limitation on the configuration of the controller 200. The controller 200 is, for example, a microcomputer. There is no specific limitation on the hardware configuration of the microcomputer. For example, the microcomputer includes an interface (I/F) to receive printing data or the like from an external device such as a host computer or the like, a central processing unit (CPU) to execute an instruction of a control program, a ROM (read only memory) to store a program to be executed by the CPU, a RAM (random access memory) usable as a working area where the program is developed, and a storage device, such as a memory or the like, to store the above-mentioned program and various types of data. The controller 200 does not need to be provided inside the printer 10, and may be, for example, a computer or the like installed outside the printer 10 and communicably connected with the printer 10 in a wired or wireless manner.

As shown in FIG. 13, the controller 200 is configured or programmed to include a hot air controller 210, a first air blowing controller 220, a second air blowing controller 230, a third air blowing controller 240, a transportation controller 250, a cutting controller 260, a data receiver 270, and a setting registration portion 280. The controller 200 may be configured or programmed to include another controller such as a controller configured or programmed to control a printing operation or the like, but such a controller is not shown or described herein.

The hot air controller 210 controls the drying device 50 such that the temperature measured by the thermistors S1 is a predetermined temperature. In this example embodiment, the hot air controller 210 controls the drying device 50 such that the temperature measured by the left thermistor S1L and the temperature measured by the right thermistor S1R are each a predetermined temperature. In more detail, as shown in FIG. 13, the hot air controller 210 includes a left hot air controller 211 and a right hot air controller 212. The left hot air controller 211 drives the left fans 132L and controls the left heaters 135L based on the temperature measured by the left thermistor S1L to control the temperature of the hot air exhausted from the left exhaust opening 102bL. The right hot air controller 212 drives the right fans 132R and controls the right heaters 135R based on the temperature measured by the right thermistor S1R to control the temperature of the hot air exhausted from the right exhaust opening 102bR.

In this example embodiment, the left hot air controller 211 and the right hot air controller 212 respectively control the left heaters 135L and the right heaters 135R such that the temperatures measured by the thermistors S1L and S1R are equal to each other. In this example embodiment, the set temperature for the hot air in the left heating chamber 102L and the set temperature for the hot air in the right heating chamber 102R are equal to each other. As described above, the temperature of the hot air in the left heating chamber 102L and the temperature of the hot air in the right heating chamber 102R are controlled independently from each other in order to suppress a variance in the amount of heat of the hot air in the left-right direction. In this example embodiment, in order to suppress the variance in the amount of heat in the left-right direction, the set temperature for the hot air in the left heating chamber 102L and the set temperature for the hot air in the right heating chamber 102R are equal to each other. Note that in the case where the variance in the amount of heat in the left-right direction is better suppressed by making the set temperature in the left heating chamber 102L different from the set temperature in the right heating chamber 102R, the set temperatures may be made different from each other.

The left hot air controller 211 is configured or programmed to include a left heater controller 211A and a left air blowing controller 211B. The left heater controller 211A controls the left heaters 135L such that the temperature measured by the left thermistor S1L is a predetermined temperature. The temperature of the hot air is controlled basically by controlling the heaters 135, and the output of the heating chamber fans 132 is switched in a predetermined case. In this example embodiment, as the temperatures of the hot air, a warm-up temperature T1, which is a temperature at the time of warm-up driving, and a printing-time temperature T2, which is a temperature at the time of the printing and is higher than the warm-up temperature T1, are set. In this example embodiment, the warm-up temperature T1 is preset. In this example embodiment, the printing-time temperature T2 is set by the user in accordance with the type of the recording medium 5. An appropriate temperature of the hot air may be different in accordance with the type of the recording medium 5. The printing-time temperature T2 is set in accordance with the type of the recording medium 5, so that higher quality printing is performed. In this example embodiment, a threshold temperature T3 higher than the warm-up temperature T1 is also set. Depending on whether the printing-time temperature T2 is set to be equal to, or lower than, the threshold temperature T3 or is set to be higher than the threshold temperature T3, the control on the left heaters 135L and on the left fan 132L varies. This will be described below in detail.

The left air blowing controller 211B controls the left fans 132L. Until the temperature of the hot air becomes the printing-time temperature T2, the left air blowing controller 211B drives the left fans 132L at an output smaller than an output after the temperature of the hot air becomes the printing-time temperature T2. In more detail, in the case where the printing-time temperature T2 is set to be higher than the threshold temperature T3, the left air blowing controller 211B drives the left fans 132L at a predetermined first heating-time output until the temperature of the hot air becomes the threshold temperature T3, drives the left fans 132L at a predetermined second heating-time output until the temperature of the hot air becomes the printing-time temperature T2, and drives the left fans 132L at a normal output after the temperature of the hot air becomes the printing-time temperature T2. In the case where the printing-time temperature T2 is set to be equal to, or lower than, the threshold temperature T3, the left air blowing controller 211B drives the left fans 132L at the first heating-time output until the temperature of the hot air becomes the printing-time temperature T2, and drives the left fans 132L at the normal output after the temperature of the hot air becomes the printing-time temperature T2. The second heating-time output is set to be larger than the first heating-time output, and the normal output is set to be still larger than the second heating-time output. The left air blowing controller 211B is configured or programmed to suppress the output of the left fans 132L until the temperature of the hot air reaches the printing-time temperature T2 and to increase the output of the left fans 132L when the temperature of the hot air reaches the printing-time temperature T2. In the case where the printing-time temperature T2 is set to be high, the left air blowing controller 211B increases the temperature of the hot air to the printing-time temperature T2 while increasing the output of the left fans 132L step by step (in this example embodiment, by switching the first heating-time output to the second heating-time output in the middle of the heating).

The right hot air controller 212 includes a right heater controller 212A and a right air blowing controller 212B. The right heater controller 212A and the right air blowing controller 212B respectively have the same functions as those of the left heater controller 211A and the left air blowing controller 211B. Hereinafter, the left heater controller 211A and the right heater controller 212A may be collectively referred to as the “heater controller 210A”, and the left air blowing controller 211B and the right air blowing controller 212B may be collectively referred to as the “air blowing controller 210B”.

The second air blowing controller 230 controls the second air blowing fans 131B to generate air that forms the air curtain. In this example embodiment, the output of the second air blowing fans 131B is switched in accordance with the temperature of the hot air. This is because the air absorbed into the heating chamber absorbing openings 102a contains the air of the air curtain. In this example embodiment, the output of the second air blowing fans 131B is switched in synchronization with the switching of the output of the air blowing controller 210B. That is, the output of the second air blowing fans 131B is controlled to be a first output when the output of the heating chamber fans 132 is the first heating-time output, is controlled to be a second output when the output of the heating chamber fans 132 is the second heating-time output, and is controlled to be a third output when the output of the heating chamber fans 132 is the normal output. The second output is set to be larger than the first output, and the third output is set to be still larger than the second output. Note that the output of the second air blowing fans 131B does not need to be switched in complete synchronization with the switching of the output of the air blowing controller 210B. For example, the output of the second air blowing fans 131B may be constant regardless of the output of the air blowing controller 210B.

The first air blowing controller 220 controls the first air blowing fans 131A to generate the air for the initial air blowing. The third air blowing controller 240 controls the non-heating chamber fans 133 to jet out the air from the non-heating chamber exhaust openings 103b.

The transportation controller 250 controls the transporter 32 to transport the recording medium 5. In this example embodiment, the transportation controller 250 is configured or programmed to transport the recording medium 5 in a form suitable to the state of the drying device 50.

The transportation controller 250 controls the transporter 32 to transport the recording medium 5 in the transportation direction X. The transportation controller 250 includes a pre-driving transportation controller 251 to control the transporter 32 to transport the recording medium 5 before the drying device 50 is driven, a pre-printing transportation controller 252 to transport the recording medium 5 before the printing is started, a printing-time transportation portion 253 to transport the recording medium 5 at the time of the printing, and a post-cutting transportation controller 254 to transport the recording medium 5 after the recording medium 5 is cut by the sheet cutter 40. Hereinafter, the transportation of the recording medium 5 performed under the control of the pre-driving transportation controller 251 will be referred to also as “pre-driving transportation”, the transportation of the recording medium 5 performed under the control of the pre-printing transportation controller 252 will be referred to also as “pre-printing transportation”, and the transportation of the recording medium 5 performed under the control of the post-cutting transportation controller 254 will be referred to also as “post-cutting transportation”.

In the case where the medium sensor S2 has sensed the recording medium 5, the pre-driving transportation controller 251 transports the recording medium 5 by a predetermined pre-driving transportation distance before the printing is started. The pre-driving transportation controller 251 is configured or programmed to, in the case where the medium sensor S2 has not sensed the recording medium 5, transport the recording medium 5 before the printing is started, until the recording medium 5 is sensed by the medium sensor S2, and then to further transport the recording medium 5 by the pre-driving transportation distance. The “pre-driving transportation distance” is set to a distance by which the recording medium 5 reaches at least the drying device 50. In this case, the pre-driving transportation distance is set to be at least longer than a distance, in the transportation direction X, between a most upstream position of a portion, of the downstream guide 14, that faces the drying device 50 and the medium sensor S2. With this arrangement, the recording medium 5 subjected to the pre-driving transportation is inserted into a gap between the downstream guide 14 and the drying device 50. After the drying device 50 is driven, the air flows in the gap between the downstream guide 14 and the drying device 50, and therefore, the recording medium 5 is not easily inserted into the gap. Therefore, the transportation controller 250 performs the pre-driving transportation of the recording medium 5 such that the recording medium 5 reaches the gap between the downstream guide 14 and the drying device 50 before the drying device 50 is driven.

More preferably, the pre-driving transportation distance is set to a distance by which the recording medium 5 reaches a portion, on the downstream guide 14, that has a narrowest interval with the drying device 50 (represented by reference sign 14N in FIG. 3). In this case, the pre-driving transportation distance is set to be longer than a distance, in the transportation direction X, between the portion 14N, on the downstream guide 14, that has the narrowest interval with the drying device 50, and the medium sensor S2. The pre-driving transportation distance is set to such a distance, so that the recording medium 5 subjected to the pre-driving transportation passes the portion 14N, on the downstream guide 14, that has the narrowest interval with the drying device 50. In this example embodiment, the pre-driving transportation controller 251 transports the recording medium 5 such that a downstream end of the recording medium 5 passes the portion 14N, on the downstream guide 14, that has the narrowest interval with the drying device 50.

It is preferred that the pre-driving transportation distance is set to a distance by which the recording medium 5 reaches a position, on the downstream guide 14, that faces the heating chamber absorbing openings 102a. In this case, the pre-driving transportation distance is set to be longer than a distance, in the transportation direction X, between the position, on the downstream guide 14, that faces the heating chamber absorbing openings 102a, and the medium sensor S2. The pre-driving transportation distance is set to such a distance, so that the recording medium 5 subjected to the pre-driving transportation passes the position facing the heating chamber absorbing openings 102a. If the pre-driving transportation distance is set to a distance by which the recording medium 5 does not reach the position, on the downstream guide 14, that faces the heating chamber absorbing openings 102a, when the drying device 50 is driven, the downstream end of the recording medium 5 may undesirably be rolled up toward the heating chamber absorbing openings 102a and stuck on the heating chamber absorbing openings 102a. The pre-driving transportation distance is set to the above-described distance, so that the recording medium 5 is suppressed from being stuck on the heating chamber absorbing openings 102a.

Furthermore, it is preferred that the pre-driving transportation distance is set to a distance by which the recording medium 5 reaches a position, on the downstream guide 14, that faces the heating chamber exhaust openings 102b. In this case, the pre-driving transportation distance is set to be longer than a distance, in the transportation direction X, between the position, on the downstream guide 14, that faces the heating chamber exhaust openings 102b, and the medium sensor S2. The pre-driving transportation distance is set to such a distance, so that the recording medium 5 subjected to the pre-driving transportation passes the position facing the heating chamber exhaust openings 102b. In this example embodiment, the pre-driving transportation controller 251 transports the recording medium 5 such that the downstream end of the recording medium 5 passes the position facing the heating chamber exhaust openings 102b. If the pre-driving transportation distance is set to a distance by which the recording medium 5 does not reach the position, on the downstream guide 14, that faces the heating chamber exhaust openings 102b, when the drying device 50 is driven, the downstream end of the recording medium 5 is rolled up by the hot air exhausted from the heating chamber exhaust openings 102b and flaps. The pre-driving transportation distance is set to the above-described distance, so that the downstream end of the recording medium 5 is suppressed from flapping and the recording medium 5 is transported smoothly. When the recording medium 5 is transported by the pre-driving transportation distance, the downstream end of the recording medium 5 also passes the position, on downstream guide 14, that faces the heating chamber absorbing openings 102a.

The pre-printing transportation controller 252 controls the transporter 32 to transport the recording medium 5 by a predetermined distance after the temperature measured by the thermistors S1 reaches the printing-time temperature T2 but before the printing is started (pre-printing transportation). Hereinafter, such a predetermined distance will be referred to also as a “pre-printing transportation distance”. When the hot air is blown to the downstream guide 14, the recording medium 5 on the downstream guide 14 is stretched and contracted by a temperature change due to the hot air. The recording medium 5 on the platen 16 is sandwiched between the pinch rollers 26 and the grit rollers 25 on the side of the upstream direction X2 of the transportation direction X, and therefore, cannot absorb the stretching and the contraction thereof caused on the downstream guide 14 by moving upstream. Therefore, when being stretched and contracted on the downstream guide 14, the recording medium 5 may undesirably rise on the platen 16. The pre-printing transportation is performed in order to resolve the rise of the recording medium 5 on the platen 16 caused by a temperature increase of the recording medium 5 on the downstream guide 14.

The pre-printing transportation distance is set to be longer than a range in which the ink head 35 is present in the transportation direction X. Even if the rise of the recording medium 5 is caused, as long as the recording medium 5 is transported in the downstream direction X1 of the transportation direction X by a length corresponding to the range in which the ink head 35 is present, a portion of the recording medium 5 that is not influenced by the heat is transported with certainty to a portion facing the ink head 35. In this example embodiment, the pre-printing transportation distance is set to be shorter than the pre-driving transportation distance of the recording medium 5 by the pre-driving transportation controller 251. Even if the pre-printing transportation distance is not much long, the rise of the recording medium 5 on the platen 16 is reduced or prevented. Therefore, the pre-printing transportation distance is set to be shorter than the pre-driving transportation distance in light of the productivity and the amount of consumption of the recording medium 5.

The post-cutting transportation controller 254 is configured or programmed to transport the recording medium 5 after the sheet cutter 40 cuts the recording medium 5 under the control of the cutting controller 260, until the recording medium 5 is sensed by the medium sensor S2, and then to further transport the recording medium 5 by the pre-driving transportation distance. Such a post-cutting transportation puts the recording medium 5 into a state same as the state after the recording medium 5 is subjected to the pre-driving transportation before the printing. The recording medium 5 subjected to the post-cutting transportation passes the position facing the heating chamber absorbing openings 102a and the position facing the heating chamber exhaust openings 102b.

The hot air controller 210 drives the heating chamber fans 132 at such an output as to prevent the downstream end of the recording medium 5 from being rolled up toward the heating chamber absorbing openings 102a, at least from the start until the end of the post-cutting transportation of the recording medium 5. Hereinafter, such an output of the heating chamber fans 132 as to prevent the downstream end of the recording medium 5 from being rolled up will be referred to also as a “post-cutting output”. The post-cutting output is also set to such an output as to prevent the downstream end of the recording medium 5 from rising from the downstream guide 14 by the hot air exhausted from the heating chamber exhaust openings 102b. At this point, the heaters 135 may be driven. The post-cutting output may be zero. That is, the heating chamber fans 132 may be stopped during the post-cutting transportation. In the case where the heating chamber fans 132 are stopped, the heaters 135 may be stopped.

The data receiver 270 receives a printing instruction. The data receiver 270 receives a printing instruction, so that the printer 10 starts a printing preparation. The printing preparation includes increasing the temperature of the hot air from the warm-up temperature T1 to the printing-time temperature T2, and the pre-printing transportation. The hot air controller 210 is configured or programmed to increase the temperature measured by the thermistors S1 to the warm-up temperature T1 and to, after the temperature is maintained at the warm-up temperature T1, increase the temperature to the printing-time temperature T2. The reception of the printing instruction acts as a trigger to start the temperature increase to the printing-time temperature T2. Upon receipt of the printing instruction by the data receiver 270 in a state where the temperature measured by the thermistors S1 is maintained at the warm-up temperature T1, the hot air controller 210 increases the temperature measured by the thermistors S1 to the printing-time temperature T2.

Note that the printer 10 in this example embodiment is configured or programmed to, during a first temperature increase after the power is turned on, maintain the temperature of the hot air at the warm-up temperature T1 for a predetermined time period regardless of whether or not there is a printing instruction. Hereinafter, the time period in which the temperature of the hot air is maintained at the warm-up temperature T1 will be referred to also as a “maintaining time period”. After increasing the temperature to the warm-up temperature T1, the hot air controller 210 maintains the temperature of the hot air at the warm-up temperature T1 until the maintaining time period elapses. With this arrangement, the temperature of the hot air is maintained at the warm-up temperature T1 at least for the maintaining time period. The drying device 50 is warmed for the maintaining time period or longer, so that the temperature of the hot air that has reached the printing-time temperature T2 is suppressed from being varied in accordance with the position. If the maintaining time period is not used and the drying device 50 is not warmed, there occurs a low-temperature portion in the drying device 50, and the temperature of the hot air is decreased due to such a low-temperature portion. Therefore, the temperature of the hot air is varied in accordance with the position. When the maintaining time period elapses and the data receiver 270 receives a printing instruction, the hot air controller 210 increases the temperature of the hot air to the printing-time temperature T2. That is, if the data receiver 270 has not received a printing instruction when the maintaining time period elapses, the hot air controller 210 maintains the temperature of the hot air at the warm-up temperature T1, and when the data receiver 270 receives the printing instruction, the hot air controller 210 immediately increases the temperature of the hot air toward the printing-time temperature T2. In the case where the data receiver 270 has already received a printing instruction when the maintaining time period elapses, the hot air controller 210 immediately increases the temperature of the hot air toward the printing-time temperature T2.

In this example embodiment, the hot air controller 210 is configured to, at the time of the warm-up driving, determine whether or not the temperature of the hot air has reached the warm-up temperature T1 based on the temperature measured by the left thermistor S1L or the temperature measured by the right thermistor S1R, whichever is higher. Such a determination shortens the time period needed for the maintaining time period of the warm-up driving to elapse. Note that whether or not the temperature of the hot air has reached the warm-up temperature T1 may be determined based on the temperature measured by the left thermistor S1L or the temperature measured by the right thermistor S1R, whichever is lower, or may be determined based on both of the temperatures (e.g., based on an average value of the temperatures). This is applicable to a determination on whether or not the temperature of the hot air has reached any other temperature, and there is no limitation on the thermistor based on which the determination is made.

In this example embodiment, the hot air controller 210 determines whether or not the temperature of the hot air has reached the printing-time temperature T2 based on an average of the temperature measured by the left thermistor S1L and the temperature measured by the right thermistor S1R. With this control, the time period needed for the temperature of the hot air to reach the printing-time temperature T2 is shortened while the hot air is guaranteed to have a temperature of a necessary level. The hot air controller 210 determines whether or not the temperature of the hot air has reached the threshold temperature T3 based on the temperature measured by the left thermistor S1L or the temperature measured by the right thermistor S1R, whichever is higher. With this control, the temperatures of the left heaters 135L and the right heaters 135R are prevented with certainty from being increased excessively.

In this example embodiment, when a printing job based on the printing instruction received by the data receiver 270 is finished, the hot air controller 210 decreases the temperature measured by the thermistors S1 to the warm-up temperature T1, and then maintains the temperature at the warm-up temperature T1. When data receiver 270 receives a new printing instruction, the hot air controller 210 increases the temperature measured by the thermistors S1 from the warm-up temperature T1 to the printing-time temperature T2. The pre-printing transportation controller 252 controls the transporter 32 to transport the recording medium 5 in the downstream direction X1 of the transportation direction X by the pre-printing transportation distance after the temperature measured by the thermistors S1 reaches the printing-time temperature T2 but before printing based on the new printing instruction is started. In this example embodiment, the pre-printing transportation is necessarily performed before one printing job is started.

The setting registration portion 280 includes a warm-up temperature setting portion 281, a printing-time temperature setting portion 282, a threshold temperature setting portion 283, a maintaining time period setting portion 284, a heating chamber fan output setting portion 285, a second air blowing fan output setting portion 286, a pre-driving transportation distance registration portion 287, and a pre-printing transportation distance registration portion 288. The warm-up temperature setting portion 281 has the warm-up temperature T1 set therein. The warm-up temperature T1 is, for example, 60 degrees. The printing-time temperature setting portion 282 has the printing-time temperature T2 set therein. The threshold temperature setting portion 283 has the threshold temperature T3 set therein. The threshold temperature T3 is, for example, 100 degrees. The maintaining time period setting portion 284 has the maintaining time period set therein. The maintaining time period is, for example, 3 minutes.

The heating chamber fan output setting portion 285 has the first heating-time output, the second heating-time output and the normal output of the heating chamber fans 132 set therein. For example, the first heating-time output is about 80%, the second heating-time output is about 90%, and the normal output is about 100%, of the full output. The second air blowing fan output setting portion 286 has the first output, the second output and the third output of the second air blowing fans 131B set therein. For example, the first output is about 40%, the second output is about 60%, and the third output is about 70%, of the full output. The heating chamber fan output setting portion 285 has the post-cutting output set therein. The post-cutting output is preferably set to, for example, about 30% or lower of the full output (about 0% or higher and about 30% or lower of the normal output). An output of about 0% corresponds to the case where the heating chamber fans 132 are stopped. The post-cutting output is set to, for example, about 20% of the normal output.

The pre-driving transportation distance registration portion 287 has the pre-driving transportation distance registered therein. The pre-driving transportation distance is, for example, about 200 mm. The pre-printing transportation distance registration portion 288 has the pre-printing transportation distance registered therein. The pre-printing transportation distance is, for example, about 50 mm. Note that the above-mentioned temperatures, time periods, outputs and distances are merely examples, and there is no specific limitation on the temperatures, time periods, outputs and distances that are set or registered in the setting registration portion 280.

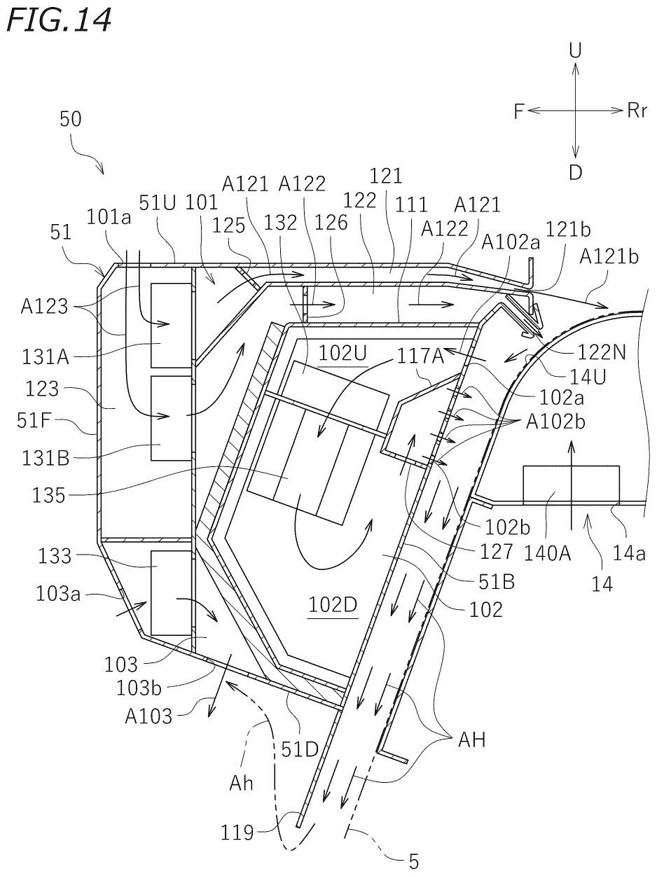

Now, an operation of the drying device 50 will be described. The drying device 50 blows air to the recording medium 5 to promote the drying of the ink on the recording medium 5. In more detail, the drying device 50 performs the initial air blowing of blowing normal-temperature air to the recording medium 5 on the platen 16. In addition, the drying device 50 blows high-temperature air to the recording medium 5 on the downstream guide 14 to promote the complete drying of the ink. FIG. 14 shows a flow of the air in the drying device 50.

As shown in FIG. 14, the air outside of the body case 51 is absorbed into the air absorbing chamber 123 from the air blowing chamber absorbing openings 101a by the first air blowing fans 131A and the second air blowing fans 131B (see arrows A123). As represented by arrow A121, the first air blowing fans 131A sends the air from the air absorbing chamber 123 to the first air blowing chamber 121, and exhausts the air from the first air blowing chamber nozzle 121b toward the platen 16. Normal-temperature air A121b exhausted from the first air blowing chamber nozzle 121b is blown to the recording medium 5 on the platen 16 and promotes the drying of the ink on the recording medium 5.

As represented by arrow A102a, the heating chamber fans 132 absorbs the air outside of the body case 51 from the heating chamber absorbing openings 102a, and sends the air from the upstream chamber 102U to the downstream chamber 102D. The air in the downstream chamber 102D is heated by the heaters 135. The temperature of the heated air is not specifically limited to any temperature, but may be, for example, about 50° C. to about 110° C. As represented by arrows A102b, the air heated to have a high temperature is exhausted from the heating chamber exhaust openings 102b. The high-temperature air exhausted from the heating chamber exhaust openings 102b is blown to the recording medium 5 on the downstream guide 14 and promotes the drying of the ink on the recording medium 5.

The air in the heating chamber 102 becomes of a high temperature, and therefore, the partition wall 111 separating the heating chamber 102 and the air blowing chamber 101 from each other is warmed by the air in the heating chamber 102. Along with the passage of the driving time of the drying device 50, the temperature of the partition wall 111 increases. Therefore, a portion, of the air in the air blowing chamber 101, that is in contact with the partition wall 111 is heated to have an increased temperature. For this reason, if the second air blowing chamber 122 is not provided, air A121 flowing in the first air blowing chamber 121 is warmed by the partition wall 111 to have a temperature higher than that of the outside air. If such high-temperature air flows out onto the platen 16, a pre-processing agent used to form an image is dried excessively, which may inhibit a reaction with the ink. In the case where the warm air flowing onto the platen also reaches an ink system (a cap, a wire, etc.), the ink attached to the ink system is easily dried, which may clog nozzles. However, according to this example embodiment, the second air blowing chamber 122 is provided between the first air blowing chamber 121 and the heating chamber 102. The air A121 in the first air blowing chamber 121 does not contact the partition wall 111. Therefore, the temperature of the air A121 in the first air blowing chamber 121 is suppressed from being increased. Air A122 flowing in the second air blowing chamber 122 provides a heat insulating function of suppressing the temperature increase of the air A121 in the first air blowing chamber 121. Therefore, air of a relatively high temperature is prevented from being blown to the recording medium 5 on the platen 16. The temperature of the air A122 flowing in the second air blowing chamber 122 is higher than the temperature of the air A121 flowing in the first air blowing chamber 121. The temperature of the air exhausted from the second air blowing chamber nozzle 122N is higher than the temperature of the air exhausted from the first air blowing chamber nozzle 121b by, for example, about 10° C. to about 20° C.

The second air blowing chamber nozzle 122N is located below the first air blowing chamber nozzle 121b and above the heating chamber absorbing openings 102a. The second air blowing chamber nozzle 122N is located between the first air blowing chamber nozzle 121b and the heating chamber absorbing openings 102a. The air (air curtain) jetted out from the second air blowing chamber nozzle 122N suppresses the high-temperature air from moving up to the first air blowing chamber nozzle 121b between the rear wall 51B of the body case 51 and the downstream guide 14. The second air blowing chamber nozzle 122N is opened rearward and downward. The air exhausted from the second air blowing chamber nozzle 122N flows downward along the rear wall 51B and the downstream guide 14 (see arrows AH). Therefore, the high-temperature air is suppressed from being mixed with the normal-temperature air exhausted from the first air blowing chamber nozzle 121b. The temperature of the air blown to the recording medium 5 on the platen 16 is suppressed from being increased.

According to this example embodiment, the drying device 50 includes the extending wall 119 extending forward and downward from the bottom wall 51D or the rear wall 51B. Therefore, high-temperature air AH is suppressed from moving around from the rear wall 51B toward the bottom wall 51D. The non-heating chamber fans 133 take the normal-temperature air into the non-heating chamber 103 from the non-heating chamber absorbing openings 103a, and blow the normal-temperature air from the non-heating chamber exhaust openings 103b. Even if the high-temperature air AH moves around toward the bottom wall 51D, the high-temperature air Ah is suppressed, by normal-temperature air A103 blown out from the non-heating chamber exhaust openings 103b, from moving around from the bottom wall 51D toward the front wall 51F. That is, the normal-temperature air A103 blown out from the non-heating chamber exhaust openings 103b plays a role of preventing the high-temperature air AH from moving up. Therefore, according to this example embodiment, the high-temperature air AH is suppressed from moving up along the front wall 51F. The temperature of the front wall 51F is suppressed from being increased. The non-heating chamber exhaust openings 103b are opened forward and downward. In this example embodiment, the orientation of the non-heating chamber exhaust openings 103b and the orientation of the rear wall 51B are parallel or substantially parallel to each other. With this arrangement, the high-temperature air AH flowing downward along the rear wall 51B is diffused farther downward.

A portion of the air of the air curtain jetted out from the second air blowing chamber nozzle 122N is taken into the heating chamber 102 from the heating chamber absorbing openings 102a. Therefore, in the case where the output of the heating chamber fans 132 is suppressed at the time of setup, it is preferred that the output of the second air blowing fans 131B is also suppressed. An operation of the printer 10 at the time of the setup will be described below.

In this example embodiment, the high-temperature air AH is suppressed from moving up along the front wall 51F, and therefore, is suppressed from being taken into the air blowing chamber absorbing openings 101a. This also suppresses the temperature increase of the air exhausted from the first air blowing chamber nozzle 121b and the second air blowing chamber nozzle 122N, and suppresses, more effectively, the temperature increase of the air blown to the recording medium 5 on the platen 16.

As described above, the high-temperature air A102b exhausted from the heating chamber exhaust openings 102b is blown to the recording medium 5 on the top wall 14U of the downstream guide 14. The recording medium 5 moves obliquely forward and downward, and therefore, a certain same portion of the recording medium 5 is not kept heated for a long time period. By contrast, the top wall 14U of the downstream guide 14 is kept heated for a long time period by the high-temperature air A102b via the recording medium 5. Therefore, the temperature of the top wall 14U of the downstream guide 14 may undesirably become high. However, according to this example embodiment, as shown in FIG. 12, the air flow paths 14E, in which the air flows, are formed inside the downstream guide 14. The air is absorbed into the air flow paths 14E from the inlet openings 14a, flows in the air flow paths 14E, and then is exhausted from the outlet openings 14b. This air cools the top wall 14U when flowing in the air flow paths 14E. Therefore, the temperature of the top wall 14U is suppressed from becoming high.

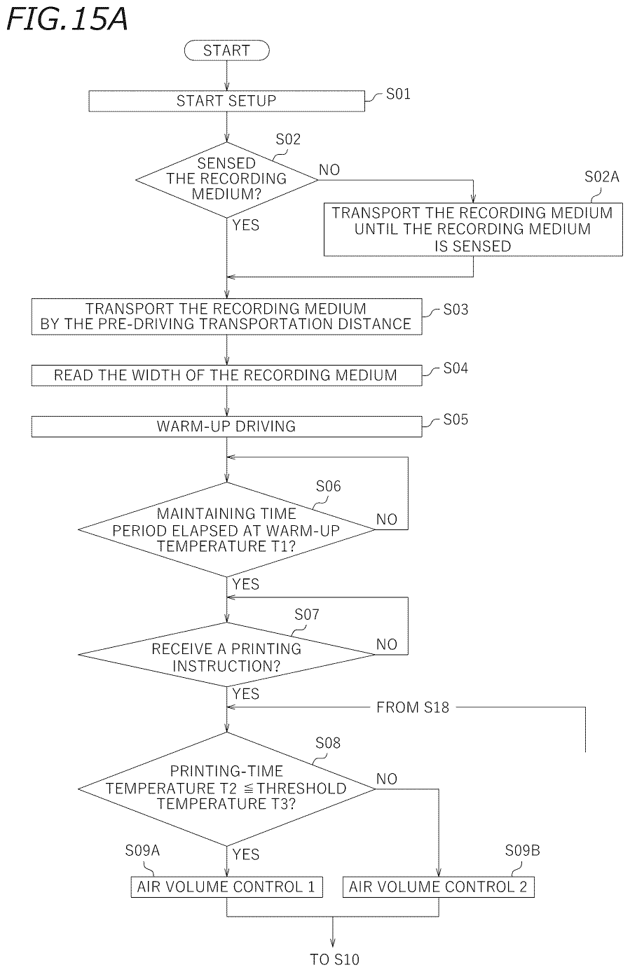

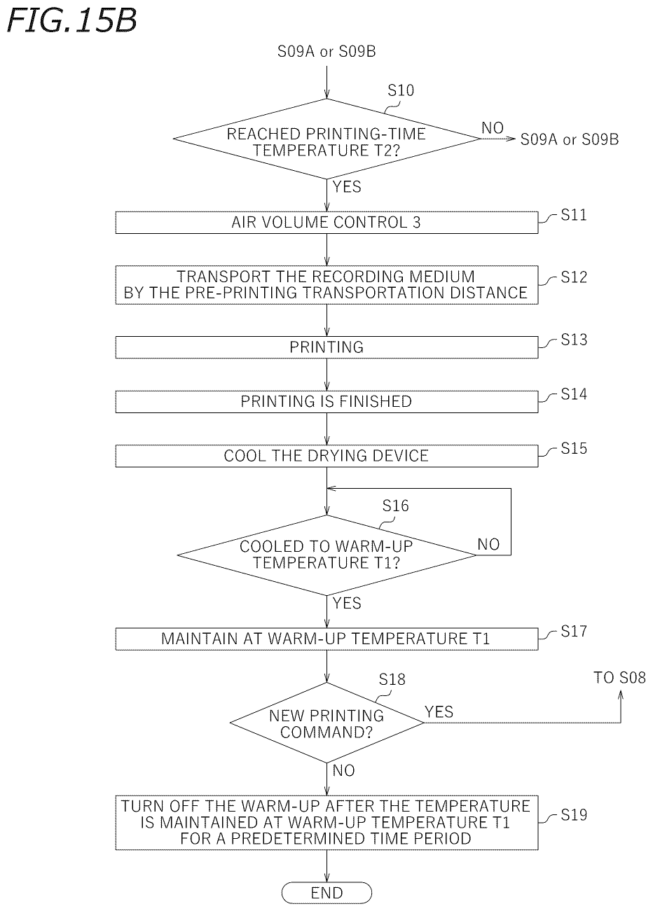

Hereinafter, an operation of the printer 10 from the start of the setup until the end of the printing will be described. FIGS. 15A and 15B are a flowchart showing an operation of the printer 10. As shown in FIG. 15A, in step S01, the setup is started, and then in step S02, the recording medium 5 is sensed by the medium sensor S2. In the case where the recording medium 5 is sensed by the medium sensor S2 in step S02 (in the case where the result of step S02 is YES), in step S03, the recording medium 5 is transported in the downstream direction X1 of the transportation direction X by the pre-driving transportation distance (e.g., 200 mm). With this control, the downstream end of the recording medium 5 passes the portion 14N (see FIG. 3), on the downstream guide 14, that has the narrowest interval with the drying device 50. In addition, the downstream end of the recording medium 5 passes an area to the rear of the heating chamber absorbing openings 102a and heating chamber exhaust openings 102b.

In the case where the recording medium 5 is not sensed by the medium sensor S2 in step S02 (in the case where the result of step S02 is NO), in step S02A, the recording medium 5 is transported until being sensed by the medium sensor S2. After step S02A, step S03 is performed. In step S04, a width of the recording medium 5 in the scanning direction Y is read by a reading device not shown or described. In this manner, the setup is finished.

In step S05, the warm-up driving is started. In the warm-up driving, first, the temperature of the hot air is increased to the warm-up temperature T1 (e.g., about 60 degrees). In step S05, the output of the heating chamber fans 132 is set to the first heating-time output (e.g., about 80%) to generate hot air. Also in step S05, the output of the second air blowing fans 131B is set to the first output (e.g., about 40%).

In this example embodiment, the temperature of the hot air is controlled independently in the left heating chamber 102L and the right heating chamber 102R. Note that the control on the temperature and the volume of the air in the left heating chamber 102L and the control on the temperature and the volume of the air in the right heating chamber 102R are substantially the same as each other, and the warm-up temperature T1 is common to the left heating chamber 102L and the right heating chamber 102R. The printing-time temperature T2 and the threshold temperature T3 are also common to the left heating chamber 102L and the right heating chamber 102R. Therefore, in the description of the operation of the printer 10, the control on the temperature and the volume of the hot air will be basically described as control on the heaters 135 and the heating chamber fans 132, unless otherwise specified.

In step S06, it is determined whether or not a predetermined maintaining time period has elapsed after the temperature of the hot air reached the warm-up temperature T1. Whether or not the temperature of the hot air has reached the warm-up temperature T1 is determined based on the temperature measured by the left thermistor S1L or the temperature measured by the right thermistor S1R, whichever reached the warm-up temperature T1 earlier. In the case where the maintaining time period has not elapsed (in the case where the result of step S06 is NO), the warm-up temperature T1 is maintained until the maintaining time period elapses. When the maintaining time period elapses (when the result of step S06 becomes YES), in step S07, it is checked whether or not a printing instruction has been received. In the case where a printing instruction has not been received (in the case where the result of step S07 is NO), the warm-up temperature T1 is maintained until the printing instruction is received. In the case where the printing instruction has already been received, or when the printing instruction is received after the elapse of the maintaining time period (in the case where the result of step S07 is YES), in step S08, it is checked whether or not the set printing-time temperature T2 is no higher than the threshold temperature T3. In the case where the printing-time temperature T2 is no higher than the threshold temperature T3 (in the case where the result of step S08 is YES), in step S09A, the temperature of the hot air is increased to the printing-time temperature T2 while first air volume control is performed. In the case where the printing-time temperature T2 is higher than the threshold temperature T3 (in the case where the result of step S08 is NO), in step S09B, the temperature of the hot air is increased to the printing-time temperature T2 while second air volume control is performed.

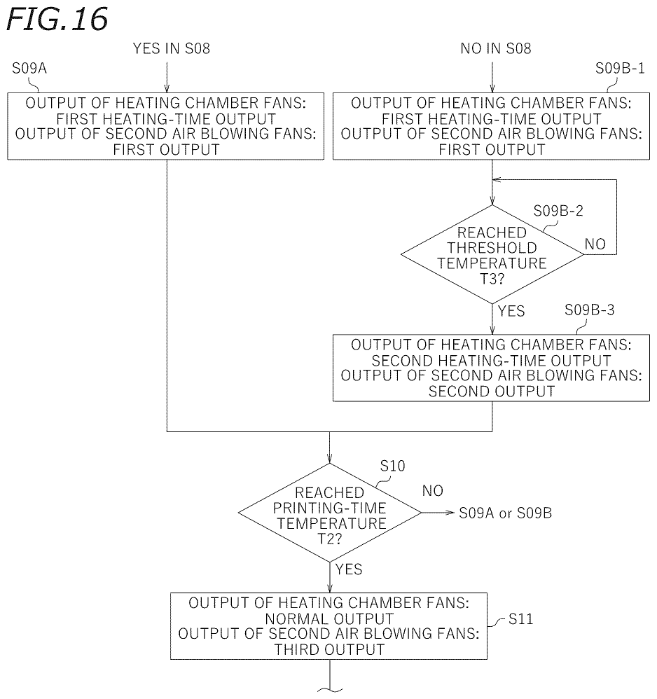

FIG. 16 is a flowchart showing the air volume control in detail. As shown in FIG. 16, in the first air volume control performed in step S09A, the output of the heating chamber fans 132 is maintained at the first heating-time output, and the output of the second air blowing fans 131B is also maintained at the first output. In the first air volume control performed in step S09A, the control on the heating chamber fans 132 and the second air blowing fans 131B is the same as the control performed during the warm-up driving.

In the second air volume control performed in step S09B also, initially, in step S09B-1, the output of the heating chamber fans 132 is maintained at the first heating-time output, and the output of the second air blowing fans 131B is also maintained at the first output. Next in step S09B-2, it is checked whether or not the temperature of the hot air has reached the threshold temperature T3. In the case where the temperature of the hot air has not reached the threshold temperature T3 (in the case where the result of step S09B-2 is NO), the operation of step S09B-1 is continued. When the temperature of the hot air reaches the threshold temperature T3 (when the result of step S09B-2 becomes YES), in step S09B-3, the output of the heating chamber fans 132 is increased to the second heating-time output (e.g., about 90%) and the output of the second air blowing fans 131B is increased to the second output (e.g., about 60%). Whether or not the temperature of the hot air has reached the threshold temperature T3 is determined based on the temperature measured by the left thermistor S1L or the temperature measured by the right thermistor S1R, whichever reached the threshold temperature T3 earlier, in order to avoid excessive increase in the temperature.

As shown in FIG. 15B, in step S10 subsequent to step S09A or step S09B, it is determined whether or not the temperature of the hot air has reached the printing-time temperature T2. Whether or not the temperature of the hot air has reached the printing-time temperature T2 is determined based on an average of the temperature measured by the left thermistor S1L and the temperature measured by the right thermistor S1R. In the case where the temperature of the hot air has not reached the printing-time temperature T2 (in the case where the result of step S10 is NO), the operation in step S09A or step S09B is continued. When the temperature of the hot air reaches the printing-time temperature T2 (when the result of step S10 becomes YES), in step S11, the temperature of the hot air is maintained at the printing-time temperature T2 while third air volume control is performed.

As shown in FIG. 16, in the third air volume control in step S11, the output of the heating chamber fans 132 is increased to the normal output (e.g., about 100%), and the output of the second air blowing fans 131B is increased to the third output (e.g., 70%). During the heating of the hot air, if the output of the heating chamber fans 132 is made large, it takes a long time period to increase the temperature. Therefore, in this example embodiment, in order to increase the temperature of the hot air quickly, during the temperature increase, the output of the heating chamber fans 132 is suppressed more than, and the volume of the air is made smaller than, those when the temperature of the hot air is maintained at the printing-time temperature T2. With this control, the temperature of the hot air is increased quickly. However, if the printing-time temperature T2 is set to be higher than the threshold temperature T3, the temperature becomes locally excessively high, which provides a high undesirable possibility that the components of the drying device 50 (specifically, the heating chamber fans 132) malfunction. If the output of the heating chamber fans 132 is made large rapidly after the temperature of the hot air reaches the high printing-time temperature T2 in a state where the output of the heating chamber fans 132 is suppressed to be small, the temperature of the hot air is decreased and thus a sufficiently high temperature of the hot air to perform the complete drying is not obtained.

Therefore, in this example embodiment, in the case where the printing-time temperature T2 is set to be higher than the threshold temperature T3, when the temperature of the hot air reaches the threshold temperature T3, the output of the heating chamber fans 132 is switched from the first heating-time output to the second heating-time output, which is larger than the first heating-time output but is smaller than the normal output. With this control, in a region where the temperature is higher than the threshold temperature T3 and the undesirable possibility that the components malfunction is high, the output of the heating chamber fans 132 is increased to decrease the undesirable possibility that the components malfunction. In addition, the temperature of the hot air is prevented from being decreased after reaching the printing-time temperature T2.

In this example embodiment, a portion of the air of the air curtain jetted out from the second air blowing chamber nozzle 122N is taken into the heating chamber 102 from the heating chamber absorbing openings 102a. While the output of the heating chamber fans 132 is suppressed at the time of the setup, it is preferred that the output of the second air blowing fans 131B is also suppressed. Therefore, in this example embodiment, the output of the second air blowing fans 131B is switched in synchronization with the switching of the output of the heating chamber fans 132.

As shown in FIG. 15B, in step S12, the recording medium 5 is transported in the downstream direction X1 of the transportation direction X by the predefined pre-printing transportation distance (e.g., about 50 mm). In this manner, the printing preparation is finished.

When the printing preparation is finished, in step S13, the printing is performed. When the printing is finished in step S14, in step S15, the drying device 50 is cooled. In step S16, it is checked whether or not the drying device 50 has been cooled down to the warm-up temperature T1. In the case where the drying device 50 has not been cooled down to the warm-up temperature T1 (in the case where the result of step S16 is NO), the cooling is continued. When the drying device 50 is cooled down to the warm-up temperature T1 (when the result of step S16 becomes YES), in step S17, the temperature of the hot air is maintained at the warm-up temperature T1.

In step S18, it is checked whether or not a new printing instruction has been received. In the case where a new printing instruction has been received (in the case where the result of step S18 is YES), the operation returns to step S08 and the temperature of the hot air is increased to the printing-time temperature T2. In the case where a new printing instruction has not been received (in the case where the result of step S18 is NO), in step S19, the drying device 50 is stopped after an elapse of a predetermined time period. When a new printing instruction is received before the predetermined time period elapses, the operation returns to step S08 and the temperature of the hot air is increased to the printing-time temperature T2.

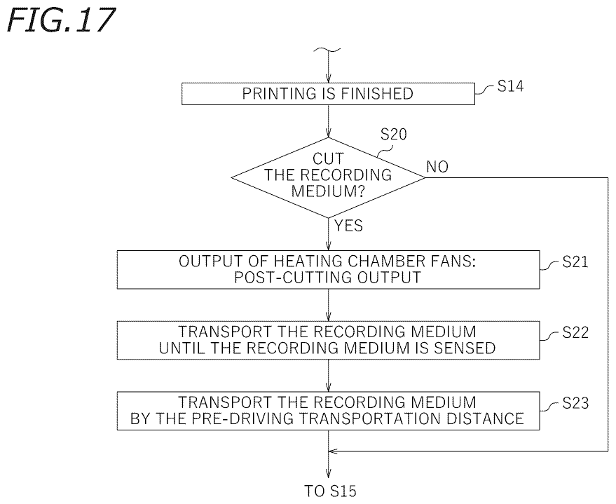

FIGS. 15A and 15B show a case where the recording medium 5 is not cut by the sheet cutter 40. There may be a case where the recording medium 5 is cut by the sheet cutter 40 after, for example, the printing. FIG. 17 is a flowchart showing an operation of the printing 10 after the recording medium 5 is cut. As shown in FIG. 17, in the case where the recording medium 5 is cut by the sheet cutter 40 in step S20 after the printing is finished (step S14) (in the case where the result of step S20 is YES), in step S21, the output of the heating chamber fans 132 is decreased to the post-cutting output. With this control, when the recording medium 5 is transported in step S23 after step S20, the recording medium 5 is suppressed from being rolled up toward the heating chamber absorbing openings 102a. If the recording medium 5 is stuck on the heating chamber absorbing openings 102a, the air is prevented from being absorbed into the heating chamber 102. When the air is not absorbed smoothly into the heating chamber 102, it may become difficult to control the temperature of the hot air or the components of the drying device 50 may malfunction.

The output of the heating chamber fans 132 is decreased to the post-cutting output, so that when the recording medium 5 is transported in step S23, the downstream end of the recording medium 5 is suppressed from being blown up and flapping by the hot air from the heating chamber exhaust openings 102b. Therefore, the undesirable possibility that the recording medium 5 is stuck in the gap between the drying device 50 and the downstream guide 14 and stops the smooth transportation of the recording medium 5 is decreased.

In step S22 subsequent to step S21, the recording medium 5 is transported in the downstream direction X1 of the transportation direction X until being sensed by the medium sensor S2. Next in step S23, the recording medium 5 is transported in the downstream direction X1 of the transportation direction X by the pre-driving transportation distance. The post-cutting transportation is basically of the same process as the pre-driving transportation. Since the output of the heating chamber fans 132 is suppressed, in step S23, the recording medium 5 is suppressed from adhering to the heating chamber absorbing openings 102a and from being blown up by the air from the heating chamber exhaust openings 102b.

Hereinafter, functions and effects provided by the printer 10 according to this example embodiment will be described.

The printer 10 according to this example embodiment includes the downstream guide 14 located beyond the platen 16 in the downstream direction X1 of the transportation direction X to guide the movement of the recording medium 5, the drying device 50 to heat the downstream guide 14, the thermistors S1 to measure the temperature of the drying device 50 or the downstream guide 14, and the controller 200. The controller 200 is configured or programmed to include the warm-up temperature setting portion 281 having the warm-up temperature T1 as the temperature at the time of the warm-up driving set therein, the printing-time temperature setting portion 282, in which the printing-time temperature T2, which is the temperature at the time of the printing and is higher than the warm-up temperature T1, is set, the hot air controller 210 configured or programmed to control the drying device 50 to control the temperature measured by the thermistors S1, and the pre-printing transportation controller 252 configured or programmed to control the transporter 32 to transport the recording medium 5. The hot air controller 210 is configured or programmed to increase the temperature measured by the thermistors S1 to the warm-up temperature T1, to maintain the temperature at the warm-up temperature T1, and then to increase the temperature to the printing-time temperature T2. The pre-printing transportation controller 252 is configured or programmed to control the transporter 32 to transport the recording medium 5 in the downstream direction X1 of the transportation direction X by a predetermined pre-printing transportation distance after the temperature measured by the thermistors S1 reaches the printing-time temperature T2 but before the printing is started.

With the printer 10 having such a configuration, the rise of the recording medium 5 on the platen 16, which is caused by the temperature increase of the recording medium 5 on the downstream guide 14 and occurs as a result of the recording medium 5 being sandwiched between the pinch rollers 26 and the grit rollers 25 and thus being immovable, is reduced or prevented by the recording medium 5 being transported by the pre-printing transportation distance.

In this example embodiment, the drying device 50 includes the heaters 135, the heating chamber 102 including the heating chamber absorbing openings 102a and the heating chamber exhaust openings 102b opened toward the downstream guide 14 and housing the heaters 135, and the heating chamber fans 132 sending the air such that the air is absorbed from the heating chamber absorbing openings 102a and is exhausted from the heating chamber exhaust openings 102b via the heaters 135. The controller 200 is configured or programmed to include the pre-driving transportation controller 251 configured or programmed to control the transporter 32 to transport the recording medium 5 until the recording medium 5 reaches at least the downstream guide 14, before the drying device 50 is driven.

With such control, the recording medium 5 reaches the downstream guide 14 before the warm-up driving is started. Therefore, the undesirable possibility that a problem occurs to the transportation of the recording medium 5 by the hot air exhausted from the drying device 50 is decreased.

In this example embodiment, the pre-driving transportation controller 251 is configured or programmed to transport the recording medium 5 such that the downstream end of the recording medium 5 passes a portion, of the downstream guide 14, that faces the heating chamber exhaust openings 102b. If the pre-driving transportation distance is set to a distance such that the recording medium 5 does not reach the portion, on the downstream guide 14, that faces the heating chamber exhaust openings 102b, when the drying device 50 is driven, the downstream end of the recording medium 5 is rolled up by the hot air exhausted from the heating chamber exhaust openings 102b and flaps. With the printer 10 according to this example embodiment, the pre-driving transportation distance is set to a distance such that the recording medium 5 reaches the portion, on the downstream guide 14, that faces the heating chamber exhaust openings 102b. Therefore, the flapping of the downstream end of the recording medium 5, which is caused by the downstream end of the recording medium 5 being rolled up by the hot air exhausted from the heating chamber exhaust openings 102b, is reduced or prevented. Thus, the transportation of the recording medium 5 is performed smoothly.

In this example embodiment, the pre-printing transportation distance is set to be longer than the range in which the ink head 35 is present in the transportation direction X. In the case where a plurality of the ink heads 35 are located in a staggered manner, the pre-printing transportation distance may be set to be longer than a distance, in the transportation direction X, between a most forward front end among front ends of the plurality of ink heads 35 and a most rearward rear end among rear ends of the plurality of ink heads 35. Even if the above-described rise of the recording medium 5 is caused, as long as the recording medium 5 is transported in the downstream direction X1 of the transportation direction X by a length corresponding to the range in which the ink head 35 is present, a portion of the recording medium 5 that is not influenced by the heat is transported with certainty to a portion facing the ink head 35. Therefore, with this configuration, the recording medium 5 and the ink heads 35 are suppressed from interfering with each other due to the rise of the recording medium 5.

In this example embodiment, the controller 200 is configured or programmed to include the data receiver 270 to receive a printing instruction. When the data receiver 270 receives a printing instruction in a state where the temperature measured by the thermistors S1 is maintained at the warm-up temperature T1, the hot air controller 210 increases the temperature measured by the thermistors S1 to the printing-time temperature T2. With such control, the temperature of the hot air is maintained at the warm-up temperature T1 until the receiver 270 receives the printing instruction, and therefore, the energy consumed by the printer 10 is decreased.

In this example embodiment, when a printing job based on the printing instruction received by the data receiver 270 is finished, the hot air controller 210 is configured or programmed to decrease the temperature measured by the thermistors S1 to the warm-up temperature T1, and then maintain the temperature at the warm-up temperature T1. When the data receiver 270 receives a new printing instruction, the hot air controller 210 is configured or programmed to increase the temperature measured by the thermistors S1 from the warm-up temperature T1 to the printing-time temperature T2. The pre-printing transportation controller 252 is configured or programmed to control the transporter 32 to transport the recording medium 5 in the downstream direction X1 of the transportation direction X by the pre-printing transportation distance after the temperature measured by the thermistors S1 reaches the printing-time temperature T2 but before printing based on the new printing instruction is started. With this configuration, even in the case where the temperature of the hot air is decreased to the warm-up temperature T1 after the printing and then is increased to the printing-time temperature T2 upon receipt of a new printing instruction, the transportation of the recording medium 5 is performed in substantially the same manner as before the printing. With this control, the rise of the recording medium 5 is reduced or prevented also in the above-described case.

The printer 10 according to this example embodiment has the following configuration.

The printer 10 according to this example embodiment includes the medium sensor S2 to sense the recording medium 5 when the recording medium 5 reaches a predetermined position that is on the downstream guide 14 (or the platen 16) and is beyond the drying device 50 in the upstream direction X2 of the transportation direction X. The controller 200 is configured or programmed to include the pre-driving transportation distance registration portion 287, in which the pre-driving transportation distance, by which the recording medium 5 is transported by the transporter 32 before the printing is started, is registered. The pre-driving transportation controller 251 is configured or programmed to, in the case where the medium sensor S2 has sensed the recording medium 5, transport the recording medium 5 by the pre-driving transportation distance before the printing is started. The pre-driving transportation controller 251 is configured or programmed to, in the case where the medium sensor S2 has not sensed the recording medium 5, transport the recording medium 5 until the recording medium 5 is sensed by the medium sensor S2 and then further transport the recording medium 5 by the pre-driving transportation distance, before the printing is started. The pre-driving transportation distance is set to a distance by which the recording medium 5 reaches at least the drying device 50.

In this example embodiment, the pre-driving transportation distance is set to a distance by which the recording medium 5 reaches the portion 14N, on the downstream guide 14, that has the narrowest interval with the drying device 50.

In this example embodiment, the drying device 50 includes the heaters 135, the heating chamber 102 including the heating chamber absorbing openings 102a and the heating chamber exhaust openings 102b opened toward the downstream guide 14 and housing the heaters 135, and the heating chamber fans 132 sending the air such that the air is absorbed from the heating chamber absorbing openings 102a and is exhausted from the heating chamber exhaust openings 102b via the heaters 135. The pre-driving transportation distance is set to a distance by which the recording medium 5 reaches the position, on the downstream guide 14, that faces the heating chamber exhaust openings 102b.

The printer 10 according to this example embodiment includes the sheet cutter 40 to cut the recording medium 5 while moving across the recording medium 5 in the scanning direction Y to cut the recording medium 5 into a downstream portion and an upstream portion. The controller 200 is configured or programmed to include the hot air controller 210 configured or programmed to control the heaters 135 and the heating chamber fans 132, and the cutting controller 260 configured or programmed to control the sheet cutter 40 to cut the recording medium 5. The transportation controller 250 is configured or programmed to, after the sheet cutter 40 cuts the recording medium 5 under the control of the cutting controller 260, transport the recording medium 5 by a predetermined distance such that the downstream end of the recording medium 5 passes a position facing the heating chamber exhaust openings 102b (in this example embodiment, to transport the recording medium 5 by the pre-driving transportation distance after the medium sensor S2 senses the recording medium 5). The hot air controller 210 is configured or programmed to stop the heating chamber fans 132, or drive the heating chamber fans 132 at an output such that the downstream end of the recording medium 5 does not rise from the downstream guide 14 due to the air exhausted from the heating chamber exhaust openings 102b, at least from the start until the end of the transportation of the recording medium 5 after the recording medium 5 is cut.

The printer 10 according to this example embodiment has the following configuration.

In this example embodiment, the controller 200 is configured or programmed to include a maintaining time period setting portion 284, in which a maintaining time period in which the temperature of the hot air is maintained at the warm-up temperature T1, is set, and the data receiver 270 to receive a printing instruction. The hot air controller 210 is configured or programmed to increase the temperature of the hot air to the warm-up temperature T1, then maintain the temperature at the warm-up temperature T1 until the maintaining time period elapses, and increase the temperature of the hot air to the printing-time temperature T2 when the maintaining time period elapses and the data receiver 270 receives a printing instruction.

In this example embodiment, until the temperature of the hot air becomes the printing-time temperature T2, the air blowing controller 210B is configured or programmed to drive the heating chamber fans 132 at an output smaller than the output after the temperature of the hot air becomes the printing-time temperature T2.

In this example embodiment, the controller 200 is configured or programmed to include the threshold temperature setting portion 283, in which the threshold temperature T3 higher than the warm-up temperature T1 is set, and the heating chamber fan output setting portion 285. In the heating chamber fan output setting portion 285, the first heating-time output of the heating temperature fans 132, the second heating-time output of the heating temperature fans 132 larger than the first heating-time output, and the normal output of the heating temperature fans 132 still larger than the second heating-time output are set. In the case where the printing-time temperature T2 is set to be higher than the threshold temperature T3, the air blowing controller 210B is configured or programmed to drive the heating temperature fans 132 at the first heating-time output until the temperature of the hot air becomes the threshold temperature T3, drive the heating temperature fans 132 at the second heating-time output until the temperature of the hot air becomes the printing-time temperature T2, and drive the heating temperature fans 132 at the normal output after the temperature of the hot air becomes the printing-time temperature T2.

In this example embodiment, the printing-time temperature T2 is set in accordance with the type of the recording medium 5.

The printer 10 according to this example embodiment has the following configuration.

In this example embodiment, the drying device 50 includes the box-shaped body case 51, the plurality of left heaters 135L, the plurality of left fans 132L, the left thermistor S1L, the plurality of right heaters 135R, the plurality of right fans 132R, and the right thermistor S1R. The inside of the body case 51 is separated into a plurality of areas including the left heating chamber 102L including the left exhaust opening 102bL, from which the hot air is exhausted, and the right heating chamber 102R including the right exhaust opening 102bR, from which the hot air is exhausted. The plurality of left heaters 135L are provided in the left heating chamber 102L. The plurality of left fans 132L send air heated by the left heaters 135L and generate hot air to be exhausted from the left exhaust opening 102bL. The left thermistor S1L measures the temperature of the hot air generated in the left heating chamber 102L. The plurality of right heaters 135R are provided in the right heating chamber 102R. The plurality of right fans 132R send air heated by the right heaters 135R and generate hot air to be exhausted from the right exhaust opening 102bR. The right thermistor S1R measures the temperature of the hot air generated in the right heating chamber 102R. The controller 200 is configured or programmed to include the left hot air controller 211 and the right hot air controller 212. The left hot air controller 211 is configured or programmed to drive the left fans 132L and controls the left heaters 135L based on the temperature measured by the left thermistor S1L to control the temperature of the hot air to be exhausted from the left exhaust opening 102bL. The right hot air controller 212 is configured or programmed to drive the right fans 132R and controls the right heaters 135R based on the temperature measured by the right thermistor S1R to control the temperature of the hot air to be exhausted from the right exhaust opening 102bR.

In this example embodiment, the left heating chamber 102L and the right heating chamber 102R are located to be arranged in a line in the scanning direction Y perpendicular to the transportation direction X of the recording medium 5. The recording medium 5 is transported in the transportation direction X, and therefore, is influenced more by a variance in the amount of heat in the scanning direction Y than a variance in the amount of heat in the transportation direction X. Thus, the above-described configuration decreases the influence by the variance in the amount of heat of the hot air in accordance with the position.

In this example embodiment, the left hot air controller 211 is configured or programmed to control the left heaters 135L such that the temperature measured by the left thermistor S1L is a predetermined temperature. The right hot air controller 212 also is configured or programmed to control the right heaters 135R such that the temperature measured by the right thermistor S1R is the same predetermined temperature.

In this example embodiment, there are the plurality of left fans 132L and the plurality of right fans 132R. With this arrangement, the number of the components and the costs of the drying device 50 and the controller 200 are decreased as compared with a configuration by which one separated heating chamber is prepared for one fan.

In this example embodiment, the controller 200 is configured or programmed to store the warm-up temperature T1, which is the temperature of the hot air at the time of the warm-up driving and is lower than the temperature at the time of the printing. At the time of the warm-up driving, the controller 200 is configured or programmed to determine whether or not the temperature of the hot air has reached the warm-up temperature T1, based on the temperature measured by the left thermistor S1L or the temperature measured by the right thermistor S1R, whichever is higher.

In this example embodiment, the controller 200 configured or programmed to store the printing-time temperature T2, which is the temperature of the hot air at the time of the printing. The controller 200 is configured or programmed to determine whether or not the temperature of the hot air has reached the printing-time temperature T2, based on an average of the temperature measured by the left thermistor S1L and the temperature measured by the right thermistor S1R.

Example embodiments of the present invention are described above. The above-described example embodiments are merely illustrative, and the present invention may be carried out in any of various other example embodiments.

For example, in the above-described example embodiments, the drying device 50 blows hot air to heat the downstream guide 14. Alternatively, a heater for the downstream guide 14 may include a heater provided so as to, for example, contact the downstream guide 14.

The example embodiments do not limit the present invention unless otherwise specified. For example, the configurations of inkjet printers according to example embodiments of the present invention are not limited to the above-described configurations.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer, comprising:
a support table to support a recording medium;
an ink head to discharge ink toward the recording medium supported by the support table;
a transporter to transport the recording medium supported by the support table in a predetermined transportation direction;
a guide located beyond the support table in a downstream direction of the transportation direction to guide a movement of the recording medium;
a heater assembly to heat the guide;
a temperature sensor to measure a temperature of the heater assembly or the guide; and
a controller configured or programmed to include:
a warm-up temperature setting portion in which a warm-up temperature, which is a temperature at the time of warm-up driving, is set;
a printing-time temperature setting portion in which a printing-time temperature, which is a temperature at the time of printing and is higher than the warm-up temperature, is set;
a temperature controller configured or programmed to control the heater assembly to control the temperature measured by the temperature sensor; and
a first transportation controller configured or programmed to the transporter to transport the recording medium,
the temperature controller is configured or programmed to increase the temperature measured by the temperature sensor to the warm-up temperature, to maintain the temperature at the warm-up temperature, and then to increase the temperature to the printing-time temperature; and
the first transportation controller is configured or programmed to transport the recording medium in the downstream direction of the transportation direction by a predetermined distance after the temperature measured by the temperature sensor reaches the printing-time temperature but before printing is started.

2. The inkjet printer according to claim 1, wherein:
the heater assembly includes:
a heater;
a heating chamber including an absorbing opening and an exhaust opening opened toward the guide, and housing the heater; and
an air blower to send air such that air is absorbed from the absorbing opening and is exhausted from the exhaust opening via the heater; and
the controller is configured or programmed to include a second transportation controller configured or programmed to the transporter to transport the recording medium until the recording medium reaches at least the guide, before the heater is driven.

3. The inkjet printer according to claim 2, wherein the second transportation controller is configured or programmed to transport the recording medium such that a downstream end of the recording medium passes a portion of the guide that faces the exhaust opening.

4. The inkjet printer according to claim 1, wherein the predetermined distance is longer than a range in which the ink head is present in the transportation direction.

5. The inkjet printer according to claim 1, wherein
the controller is configured or programmed to include a receiver to receive a printing instruction; and
when the receiver receives the printing instruction in a state where the temperature measured by the temperature sensor is maintained at the warm-up temperature, the temperature controller is configured or programmed to increase the temperature measured by the temperature sensor to the printing-time temperature.

6. The inkjet printer according to claim 5, wherein
when a printing job based on the printing instruction received by the receiver is finished, the temperature controller is configured or programmed to decrease the temperature measured by the temperature sensor to the warm-up temperature and then maintain the temperature at the warm-up temperature, and when the receiver receives a new printing instruction, the temperature controller is configured or programmed to increase the temperature measured by the temperature sensor from the warm-up temperature to the printing-time temperature; and
the first transportation controller is configured or programmed to control the transporter to transport the recording medium in the downstream direction of the transportation direction by the predetermined distance after the temperature measured by the temperature sensor reaches the printing-time temperature but before printing based on the new printing instruction is started.
